(19) United States
(12) Patent Application Publication
(10) Pub. No.: US 2012/0114136 A1
(43) Pub. Date: May 10, 2012

(54) SPEAKER DEVICE

(75) Inventors: Minoru Horigome, Yamagata (JP); Yasuhisa Abe, Yamagata (JP); Toshihiro Hikichi, Yamagata (JP)

(73) Assignees: TOHOKU PIONEER CORPORATION, Yamagata (JP); PIONEER CORPORATION, Kawasaki-shi, Kanagawa (JP)

(21) Appl. No.: 13/382,376

(22) PCT Filed: Jul. 9, 2009
(86) PCT No.: PCT/JP2009/062481

§ 371 Date: Jan. 5, 2012

(51) Int. Cl. H04R 9/06; H04R 31/00; H04R 9/04

(52) U.S. Cl. 381/86; 381/398; 29/896.23

(57) ABSTRACT

A speaker device has a diaphragm, a static part vibratably supporting the diaphragm in a vibration direction and a driving part applying vibration to the diaphragm in response to an audio signal. The driving part is provided at the static part. The driving part includes a magnetic circuit forming a magnetic gap in a direction different from the vibration direction of the diaphragm, a voice coil vibrating along the magnetic gap, and a vibration direction converter part direction-converting the vibration of the voice coil and transmitting the vibration to the diaphragm. The vibration direction converter part includes a link body angle-converting a link part formed between the voice coil and the diaphragm. The static part includes an outer peripheral frame part surrounding the diaphragm and a bridge part bridging the inside of the outer peripheral frame part.

### BACKGROUND

1. Field of the Invention

The present invention relates to a speaker device.

2. Background Art

A dynamic speaker device is known as a typical speaker device (for example, see patent literature 1). The dynamic speaker device, for example, as shown in FIG. 1, includes a frame 3J, a cone-shaped diaphragm 21J, an edge 4J through which the diaphragm 21J is supported by the frame 3J, a voice coil bobbin 610J joined to the inner periphery part of the diaphragm 21J, a damper 7J through which the voice coil bobbin 610J is supported by the frame 3J, a voice coil 611J wound around the voice coil bobbin 610J, a yoke 51J, a magnet 52J, a plate 53J, and a magnetic circuit forming a magnetic gap in which the voice coil 611J is arranged. In this speaker device, when an audio signal is inputted to the voice coil 611J, the voice coil bobbin 610J vibrates by a Lorentz force developed in the voice coil 611J in the magnetic gap and the diaphragm 21J is driven by the vibration.

[Patent literature 1] Publication of unexamined patent application H8-149596 (FIG. 1)

### SUMMARY

The typical dynamic type speaker device as described above is configured such that the voice coil 611J is disposed opposite to the sound emission side of the diaphragm 21J and the vibration directions of the voice coil 611J and the voice coil bobbin 610J are the same as the vibration direction of the diaphragm 21J, for example, as shown in FIG. 1. In the speaker device as configured above, a region for vibration of the diaphragm 21J, a region for vibration of the voice coil bobbin 610J, and a region for arranging the magnetic circuit, etc. are necessarily formed in the vibration direction (sound emission direction) of the diaphragm 21J. Accordingly, the total height of the speaker device necessarily becomes comparatively large.

Specifically, as shown in FIG. 1, the dimension of the above-mentioned speaker device in the vibration direction of the diaphragm 21J includes (a) the total height of the cone-shaped diaphragm 21J in the vibration direction and the edge 4J through which the diaphragm 21J is supported by the frame 3J, (b) the height of the voice coil bobbin from the joining part of the diaphragm 21J and the voice coil bobbin 610J to the upper end of the voice coil 611J, (c) the total height of the voice coil, (d) the height mainly of the magnet of the magnetic circuit, corresponding to the height from the lower end of the voice coil 611J to the upper end of the yoke 51J, (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to secure a sufficient electromagnetic force. Accordingly, particularly in a speaker device adapted to a large sound volume, the total height of the speaker device inevitably becomes large.

Since the vibration direction of the voice coil bobbin 610J is the same as that of the diaphragm 21J in the conventional speaker device as described above, the total height of the speaker device inevitably becomes large to secure a vibration stroke of the voice coil bobbin 610J, when seeking a large volume sound with large amplitude of vibration of the diaphragm 21J. Thus, it becomes difficult to make a thin device. In other words, making a thin device and securing a loud sound are contradictory to each other.

In order to ensure the large amplitude of vibration of a voice coil while pursuing a reduction in thickness of a speaker device, a voice coil may be configured to vibrate in a direction crossing the vibration direction of a diaphragm. However, in order to achieve such a vibration system, it is required to consider how to arrange in flat space a driving part vibrating a voice coil and how to transmit the vibration of the voice coil efficiently to the diaphragm. If the vibration direction of a voice coil is different from the vibration direction of a diaphragm, the vibration of the voice coil may not be reliably transmitted to the diaphragm, which may lead to the degraded reproducing efficiency of a speaker device.

One or more embodiments of the present invention provides a thin speaker device capable of emitting loud reproduced sound, achieve a speaker device with high reproducing efficiency by reliably transmitting the vibration of a voice coil to a diaphragm and so forth.

A speaker device according to one or more embodiments of the present invention includes a diaphragm, a static part vibratably supporting the diaphragm in a vibration direction and a driving part applying vibration to the diaphragm in response to an audio signal, the driving part being provided at the static part. The driving part includes a magnetic circuit forming a magnetic gap in a direction different from the vibration direction of the diaphragm, a voice coil vibrating along the magnetic gap and a vibration direction converter part direction-converting the vibration of the voice coil and transmitting the vibration to the diaphragm. The vibration direction converter part includes a link body angle-converting a link part formed between the voice coil and the diaphragm, and the static part includes an outer peripheral frame part surrounding the diaphragm and a bridge part bridging the inside of the outer peripheral frame part, and the bridge part applies a reaction force to the link body and has rigidity in the vibration direction of the link body.

### BRIEF DESCRIPTION OF THE DRAWINGS

FIG. 1 is a view illustrating a conventional speaker device;

FIG. 2 is a view illustrating a basic configuration of a speaker device according to an embodiment of the present invention (FIG. 2(a) is a cross-sectional view taken in X axial direction, FIG. 2(b) is a view illustrating the action of a driving part);

FIG. 3 is a view illustrating a configuration example and the action of a vibration direction converter part;

FIG. 4 is a view illustrating a configuration example and the action of a vibration direction converter part;

FIG. 5 is a view illustrating an example of forming a vibration direction converter part (FIG. 5(a) is a side view, FIG. 5(b) is a perspective view, and FIG. 5(c) is an enlarged view of portion A);

FIG. 6 is a view illustrating an example of forming a vibration direction converter part;

FIG. 7 is a view illustrating a speaker device employing a vibration direction converter part (FIG. 7(a) is a cross-sectional view taken in X axial direction, and FIG. 7(b) is a view illustrating the action of a driving part);

FIG. 8 is a view illustrating a speaker device employing a vibration direction converter part (FIG. 8(a) is a cross-sectional view taken in X axial direction, and FIG. 8(b) is a view illustrating the action of a driving par.);

FIG. 9 is a view illustrating a specific vibration direction converter part;

FIG. 10 is a view illustrating a specific vibration direction converter part;

FIG. 11 is a view illustrating a specific vibration direction converter part;

FIG. 12 is a view illustrating a specific vibration direction converter part;

FIG. 13 is a view illustrating a specific vibration direction converter part;

FIG. 14 is a view illustrating a specific vibration direction converter part;

FIG. 15 is a view illustrating an example of configuring a static part in a speaker device according to an embodiment of the present invention;

FIG. 16 is a view illustrating an example of configuring a static part in a speaker device according to an embodiment of the present invention;

FIG. 17 is a view illustrating an example of configuring a static part in a speaker device according to an embodiment of the present invention;

FIG. 18 is a view illustrating an example of configuring a static part in a speaker device according to an embodiment of the present invention;

FIG. 19 is a view illustrating an assembly structure of a speaker device according to an embodiment of the present invention;

FIG. 20 is a view illustrating an assembly structure of a speaker device according to an embodiment of the present invention;

FIG. 21 is a view illustrating an assembly structure of a speaker device according to an embodiment of the present invention;

FIG. 22 is a view illustrating an embodiment of the present invention;

FIG. 23 is a view illustrating an embodiment of the present invention;

FIG. 24 is a view illustrating an embodiment of the present invention;

FIG. 25 is a view illustrating an embodiment of the present invention;

FIG. 26 is a view illustrating an embodiment of the present invention;

FIG. 27 is a view illustrating an embodiment of the present invention; and

FIG. 28 is a view illustrating a vehicle equipped with a speaker according to an embodiment of the present invention.

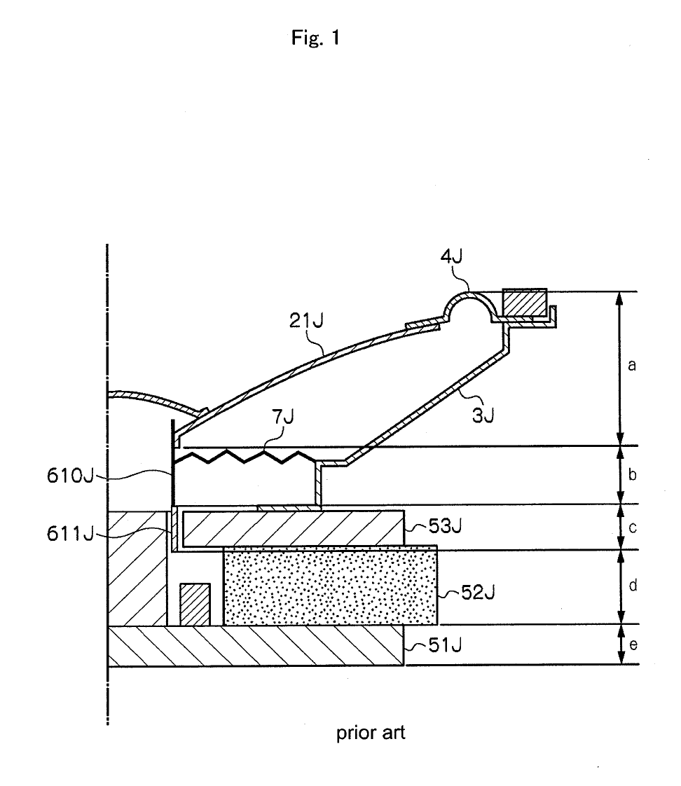

### DETAILED DESCRIPTION

Hereinafter, embodiments of the present invention are described with reference to the drawings. The embodiments of the present invention include what is shown in the drawings, but are not limited to this alone. In the description hereinafter, the same symbol is applied to the same part as the part that has already been described, and thus a part of the same description may not be repeated. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

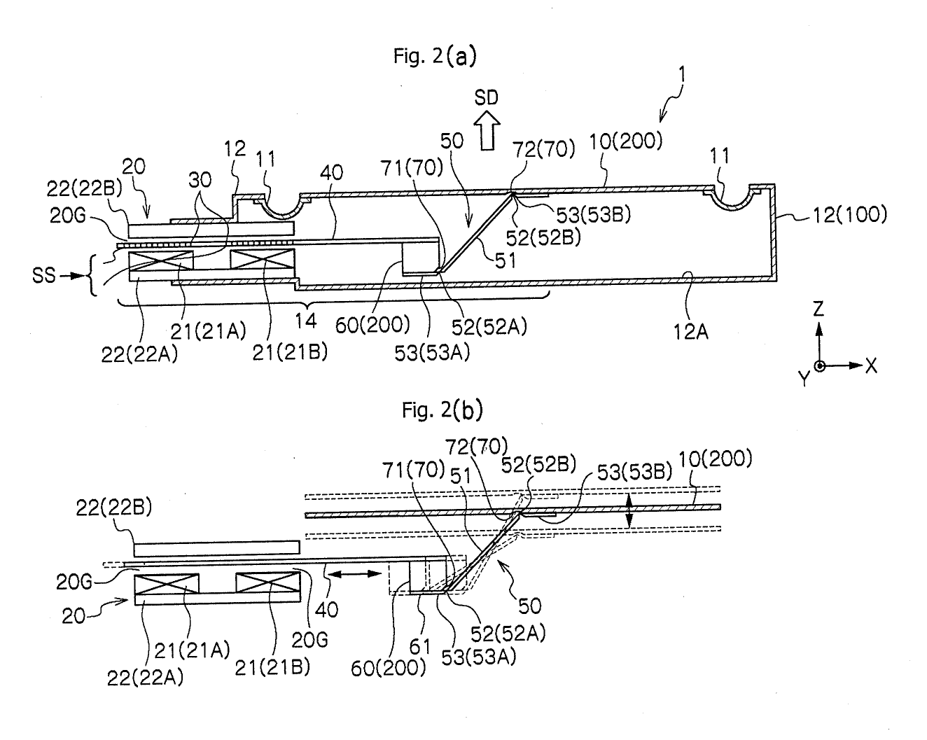

### [Basic Configuration of a Speaker Device: FIG. 2]

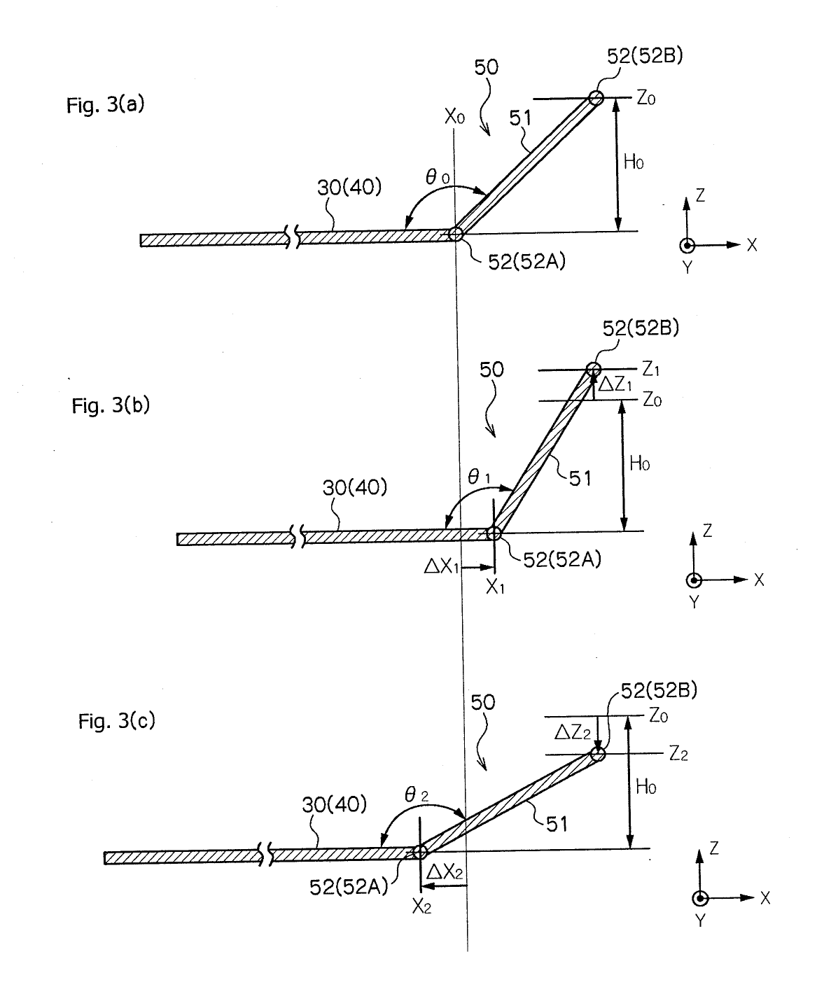

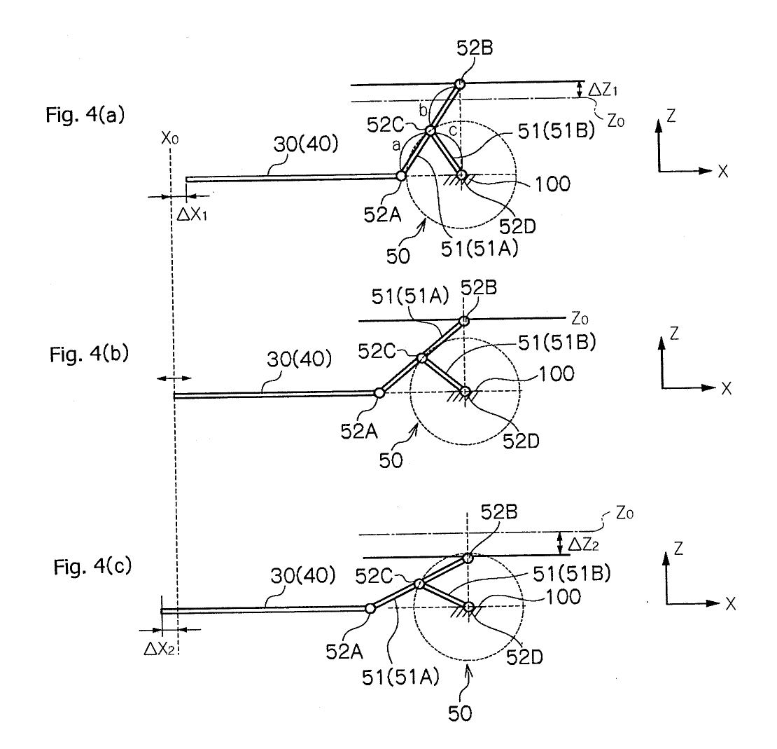

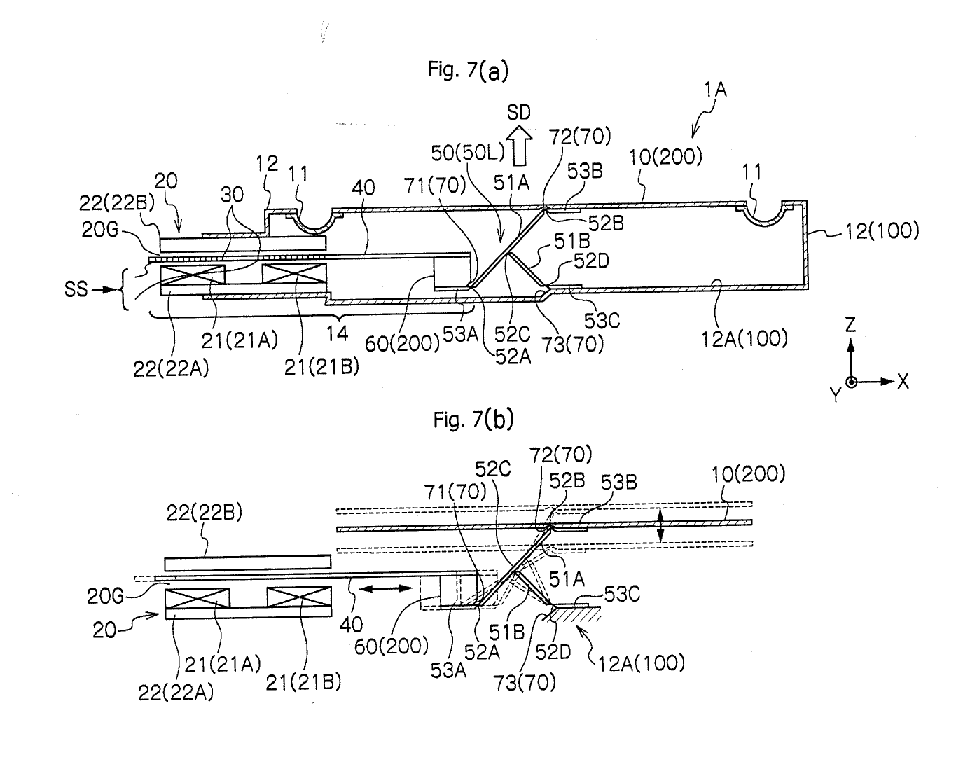

FIG. 2 is a view illustrating a basic configuration of a speaker device according to an embodiment of the present invention (FIG. 2(a) is a cross-sectional view taken in X axial direction, FIG. 2(b) is a view illustrating the action of a driving part). A vibration direction converter according to an embodiment of the present invention is shown in FIG. 7 and thereafter, which is described later, and the basic action is shown in FIG. 4. However, for example, in FIGS. 2 and 3, a vibration direction converter part that is different from FIG. 4 is shown for the purpose of brevity.

A speaker device 1 is provided with a diaphragm 10, a static part 100 and a driving part 14. The static part 100 vibratably supports the diaphragm 10 in a vibration direction. The driving part 14 is provided at the static part 100 and applies vibration to the diaphragm 10 in response to an audio signal. The driving part 14 includes a magnetic circuit 20 forming a magnetic gap 200, a voice coil 30 receiving the audio signal and vibrating in a direction different from the vibration direction of the diaphragm 10, and a vibration direction converter part 50 direction- converting the vibration of the voice coil 30 and transmitting the vibration to the diaphragm 10. In the drawing, the voice coil 30 is supported by a voice coil support part 40, however, the voice coil 30 itself may be connected with the vibration direction converter part 50. Here, the vibration direction of the voice coil 30 is set to be in X axial direction and two directions orthogonal to the direction are set to be in Y axial direction and Z axial direction respectively.

The diaphragm 10 may be formed substantially in a rectangular shape, a circular shape, an ellipsoidal shape or other shapes in the plan view. Further, the cross-sectional shape of the diaphragm 10 may be formed in a prescribed shape, for example, such as a tabular shape, a dome shape, a cone shape, etc. The cross-sectional shape of the diaphragm 10 is planar as shown in the drawings, however it may be formed in a curved shape. Further, the speaker device 1 may be made thin by making the total height of the diaphragm 10 comparatively small as necessary.

The static part 100 is a collective term for those that support vibrations of the diaphragm 10, the driving part 14, etc., which includes the frame 12 and those that have also a function of the frame 12 such as an after-mentioned yoke, a mounting unit, etc. The static part 100 is, however, not necessarily completely static. The whole static part 100 may vibrate subject to vibration of the driving part 14 or other force. The outer periphery part of the diaphragm 10 is supported via an edge 11 by the frame 12 as the static part 100.

The driving part 14 has the magnetic circuit 20, the voice coil 30 (driving member) and the vibration direction converter part 50. The voice coil 30 vibrates in one axial direction along the magnetic gap 20G of the magnetic circuit 20 and the vibration direction converter part 50 direction-converts the vibration and transmits the vibration to the diaphragm 10. The voice coil 30 vibrates in X-axial direction and the diaphragm 10 is vibratably arranged in Z-axial direction orthogonal to X-axial direction as shown in the drawings. The vibration direction converter part 50 converts the vibration of the voice coil 30 in X-axial direction into a vibration at obliquely disposed angle of its own displacement, and thus vibrating the diaphragm 10 in Z-axial direction.

The magnetic circuit 20 has a magnet 21 (21A, 21B) and a magnetic pole member(yoke) 22 (22A, 22B) such that a plurality of the magnetic gaps 20G are arranged in vibration direction of the voice coil 30, for example, in X-axial direction. In this embodiment, the magnetic pole direction of the magnet 21 (21A, 21B) is set such that magnetic field directions of a pair of the magnetic gaps 20G are opposite to each other (±Z-axial direction). The voice coil 30 made up of a wound conducting member is arranged such that currents flow in directions opposite to each other (±Y-axial direction) in the magnetic gap 20G having magnetic fields in directions opposite to each other. Thereby, a driving force (Lorentz force, electromagnetic force) may be developed in the voice coil 30 in directions (±X-axial directions) along the magnetic gap 20G. Relationship of arrangement between the magnet 21 and the magnetic pole member (yoke) 22 is not limited to the example shown in the drawings.

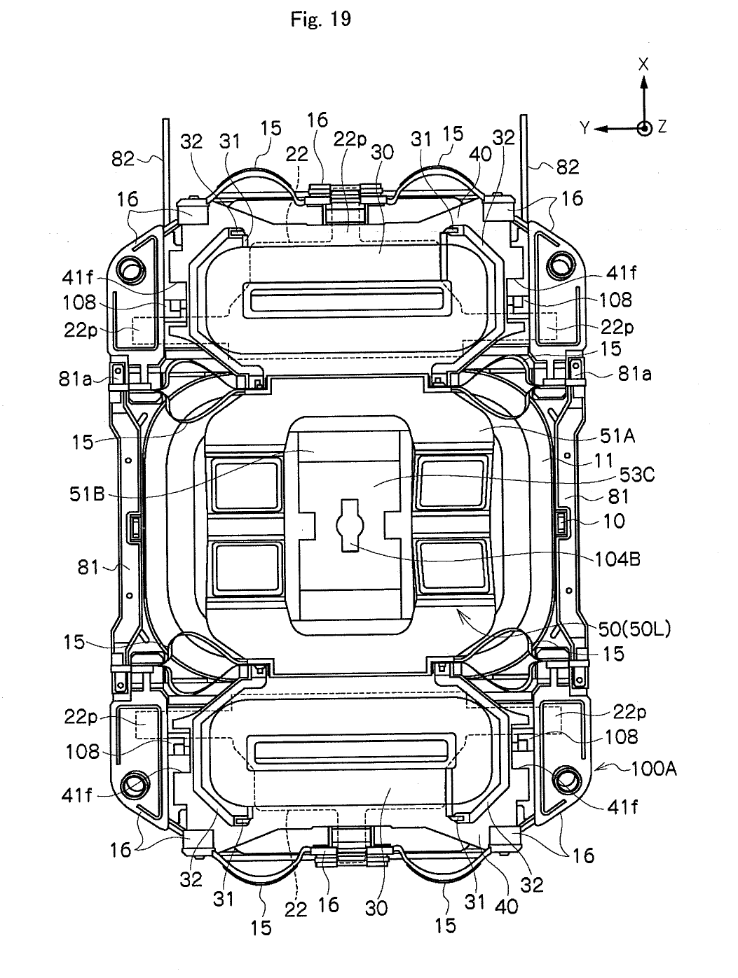

The voice coil 30 is formed by winding a conducting wire (conducting member) to which the audio signal is inputted, and the voice coil 30 itself is vibratably arranged at the static part 100 or is vibratably arranged via the voice coil support part 40 at the static part 100. For example, the voice coil support part 40 may be formed with a plane shaped insulating member, and the voice coil 30 is supported on the surface or inside the voice coil support part 40. By forming the voice coil support part 40, for example, with the plane shaped insulating member, it is possible to add rigidity (including bending rigidity and torsional rigidity) to the entire voice coil 30. Further, a plurality of conducting layers is formed outside the conducting wire on the plane shaped insulating member as the voice coil support part 40. The conducting layer 32 (see FIG. 19) is electrically connected to a lead wire 31 (see FIG. 19) which is pulled out of the start and end points of the conducting wire. The lead wire 31 (see FIG. 19) is constituted, for example with a part of conducting member which is described later. Further, the lead wire is electrically connected to the outside via an after-mentioned holding part 15 (see FIG. 19), thereby functioning as a junction wire inputting the outside audio signal into the voice coil 30. Further, for example, when a conducting wire which is not fixed to the voice coil is wound as a junction wire in a speaker device, space for wiring a tinsel wire is separately required. However, the conducting layer 32 as the junction wire (see FIG. 19) is formed on the surface of the voice coil support part 40, whereby the space for the junction wire is no longer required, and thus it is possible to reduce the thickness of the speaker device. In an example shown in the drawing, the voice coil 30 and the voice coil support part 40 are formed in a plane shape, but they are not limited to this configuration and may be formed in a cylindrical shape. Further, if the voice coil 30 or the voice coil support part 40 supporting the voice coil 30 is formed in a cylindrical shape, a plane shaped cap part may be attached to the end part on the side of the vibration direction converter part 50 such that the vibration direction converter part can be angle-variably connected with the voice coil 30 or the voice coil support part 40.

The voice coil 30 is held on the static part 100 with a holding part not shown in the drawings. The holding part is configured to vibratably hold the voice coil 30 or the voice coil support part 40 in vibration direction (for example, X-axial direction) with respect to the static part 100 and restrict them not to move in other directions. For example, the holding part is deformable in the vibration direction (for example, X-axial direction) of the voice coil 30. And the holding part may be formed with a curved plate member having rigidity in a direction crossing this vibration direction. Further, the length of the voice coil 30 in the direction orthogonal to the vibration direction of the voice coil thereof may be comparatively long with respect to the length of the voice coil 30 in the vibration direction of the voice coil so that a comparatively large driving force may be produced when driving a speaker.

The vibration direction converter part 50 includes a rigid link part 51 angle-variably and obliquely disposed between the voice coil 30 or the voice coil support part 40 and the diaphragm 10, and a hinge part 52, which is formed at both ends of the link part 51 and functions as a fulcrum for angle change of the vibration direction converter part 50. The connecting part 53 of the vibration direction converter part 50 is connected to the diaphragm 10, the voice coil 30, or an attaching counterpart 200 including other member than the diaphragm 10 or the voice coil 30 with a connecting member including a joining member such as an adhesive or a double-faced tape, and a fastener member such as a screw, etc. The hinge part 52 is arranged in proximity of the attaching counterpart 200. The connecting part 53 (53A) at the end of the vibration direction converter part 50 is connected to the voice coil 30 or the voice coil support part 40 via a connecting part 60 as shown in the drawings. However, the connecting part 53 (53A) may be directly connected without the connecting part 60. The connecting part 60 is formed between the end of the vibration direction converter part 50 on the voice coil side and the end of the voice coil 30 or the voice coil support part 40 on the side of vibration direction converter part, and thereby both ends are connected spaced apart in the vibration direction. Further, the connecting part 60 absorbs the thickness of the magnetic circuit 20, thus making the speaker device thin.

Further, a contact avoiding part 70 avoiding contact with the hinge part 52 is formed on the surface side of the attaching counterpart 200 in proximity of the hinge part 52 of the vibration direction converter part 50. The contact avoiding part 70 also functions as a joining member housing part (restraining part), which houses and restrains the joining member joining the vibration direction converter part 50 and the attaching counterpart 200. The contact avoiding part 70 is, for example, a recessed portion, a notch part, a groove part, etc., which is formed in a recessed shape along the hinge part 52. Accordingly, a predetermined space is formed between the hinge part 52 and the surface of the attaching counterpart 200 arranged near the hinge part 52 and thus preventing the adhesive material provided between the vibration direction converter part 50 and the attaching counterpart 200 from affecting the hinge part 52. As shown in the drawings, the notch part 71 as the contact avoiding part 70 is formed at the connecting part 60, which is the attaching counterpart 200, such that the notch part 71 is located in proximity of the hinge part 52 (52A), while the recessed portion 72 as the contact avoiding part 70 is formed at the diaphragm 10, such that the recessed portion 72 is located in proximity of the hinge part 52 (52B). As such, when the connecting part 53 of the vibration direction converter part 50 and the connecting part 60 or the end face of the diaphragm 10 are applied with the joining member such as adhesive, double-faced tape, etc., the adhesive and the end of the double-faced tape running off toward the hinge part 52 enter into the notch part 71 or the recessed portion 72, and thus preventing them from contacting and adhering to the hinge part 52.

In the above-mentioned speaker device 1, when an audio signal SS as an electric signal is inputted to the voice coil 30 of the driving part 14 as shown in FIG. 2 (a), the voice coil 30 or the voice coil support part 40 vibrates along the magnetic gap 200 of the magnetic circuit 20, for example, in X-axial direction of the drawings as shown in FIG. 2 (b). Accordingly, the vibration is direction-converted by the vibration direction converter part 50 and the vibration is transmitted to the diaphragm 10 such that the diaphragm 10 is vibrated, for example, in Z-axial direction of the drawings, thereby a sound in response to the audio signal is emitted in the sound emission direction SD.

In the speaker device 1 as described above, since the direction of the vibration produced by the voice coil 30 and the vibration direction of the diaphragm 10 are different from each other by using the vibration direction converter part 50, the thickness of the speaker device 1 on the rear side of the diaphragm 10 may be made smaller than the thickness of the speaker, of which the voice coil 30 is vibrated in the vibration direction of the diaphragm 10. As such, a thin speaker device, which may reproduce a low frequency range with a high sound pressure, may be realized.

Further, since the vibration produced by the voice coil 30 is direction-converted by the vibration direction converter part 50 and the vibration is transmitted to the diaphragm 10, the thickness in sound emission direction of the speaker device 1 (total height of the speaker device) is not increased even if the amplitude of vibration of the diaphragm 10 is increased by increasing the amplitude of vibration of the voice coil 30. As such, a thin speaker device which may emit a loud reproduced sound can be obtained.

Further, when the connecting part 53 of the vibration direction converter part 50 and the attaching counterpart 200 are connected to each other by using the adhesive as an joining member, if the adhesive spreads out and runs off toward the hinge part 52 due to the join, and adheres to the hinge part 52, the hinge part 52 may be hardened and lose mobility. Also, when the double-faced tape is used as the joining member, if the end of the double-faced tape runs off toward the hinge part 52 and the double-faced tape adheres to the hinge part 52, the hinge part 52 may be hardened and lose mobility. In addition, the hinge part 52, which is adhered to and hardened by the adhesive, the end of the double-faced tape, etc. adhered thereto, may be subject to fracture by the repetition of bending, folding or rotational motion. If the hinge part 52 fractures as described above, the part to which the adhesive or the end of the double-faced tape adheres may repeatedly contact with and separate from the diaphragm 10, the voice coil 30 or the attaching counterpart 200 as other members, etc., and thus an abnormal noise (contact sound) may be generated each time. On the other hand, if the applied volume of the adhesive or the joining area by the double-faced tape is limited such that the adhesive or the double-faced tape does not run off and adhere to the hinge part 52, the connecting force between the vibration direction converter part 50 and the attaching counterpart 200 may be reduced, then detachment, etc. may occur at the end face, causing abnormal noise, or if a total detachment occurs, the speaker may eventually be fractured. Furthermore, since the hinge part 52 is arranged near the attaching counterpart 200, the hinge part 52 may contact the attaching counterpart 200. Therefore, the hinge part 52 damages, or there is a case that the vibration direction converter part 50 cannot bend, fold or rotate with respect to the attaching counterpart 200. However, in this speaker device 1, since the contact avoiding part 70 is formed on the surface side of the attaching counterpart 200 in proximity of the hinge part 52, it is possible to prevent the attaching counterpart 200 from contacting the hinge part 52 and restrain the generation of abnormal noise, etc. due to the contact. Further, even if the joining member such as the adhesive, double-faced tape, etc., which is used for connecting the connecting part 53 of the vibration direction converter part 50 and the attaching counterpart 200, runs off, the joining member enters into the contact avoiding part 70 that also functions as a joining member restraining part, and thus it is possible to restrain adherence of the joining member to the hinge part 52 causing hindrance to mobility thereof. As such, the function of the hinge part 52 may be maintained while the connecting force between the vibration direction converter part 50 and the attaching counterpart 200 is maintained large. Since the vibration direction converter part 50 securely bends, folds or rotates with respect to the attaching counterpart 200, contact of the hinge part 52 to the attaching counterpart 200, generation of the abnormal noise, etc. due to fracture may be restrained.

### [Vibration Direction Converter Part: FIGS. 3 to FIG. 14]

FIGS. 3 and 4 are views illustrating a configuration example and an operation of the vibration direction converter part 50. The rigid vibration direction converter part 50, direction-converting the vibration of the voice coil 30 and transmitting it to the diaphragm 10, has hinges 52 formed on the sides of the diaphragm 10 and the voice coil 30 respectively, and has the link part 51 obliquely disposed with respect to the vibration direction of the voice coil 30. The hinge part 52 is a part that rotatably joins two rigid members or a part that bends or bendably joins integrated two rigid parts, while the link part 51 is a rigid part having the hinge parts 52 formed at the ends. The rigidity means that the members and the parts are not so deformable that the vibration of the voice coil 30 can be transmitted to the diaphragm 10. It does not mean that they are totally undeformable. The link part 51 can be formed in a plate shape or in a rod shape.

In the embodiment shown in FIG. 3, one link part 51 has the hinge parts 52 (52A, 52B)formed at both ends such that the one hinge part 52A is formed at the end of the voice coil 30 or the voice coil support part 40, while another hinge part 52B is formed on the side of the diaphragm 10. Another hinge part 52B may be connected to the diaphragm 10 or connected to the diaphragm 10 via other member. A conventional member may be used as other member. For example, a metal material, etc. improving join strength between the hinge part 52 and the diaphragm 10, may be selected (diaphragm 10 is not shown in FIG. 3).

FIG. 3(a) shows that the link part 51 is in the middle position of the vibration. The link part 51 is obliquely disposed between the voice coil 30 (or voice coil support part 40) and the diaphragm 10 at an angle θ₀. Meanwhile, the hinge part 52B on the side of the diaphragm 10 is arranged at the position Z₀ apart from the voice coil 30 by distance H₀ in the vibration direction of the diaphragm 10. The vibration direction of the voice coil 30 (or voice coil support part 40) is restricted such that it may vibrate in one axial direction (for example, X-axial direction), while the vibration direction of the diaphragm 10 is restricted such that it may vibrate in a direction (for example, Z-axial direction) different from the vibration direction of the voice coil 30.

As shown in FIG. 3(b), when the hinge part 52A formed at the end of the voice coil 30 moves from position X₀ to position X₁ by ΔX₁, in the vibration direction (X-axial direction), the inclination angle of the link part 51 is converted to be θ₁(θ₀>θ₁)and the position of the hinge part 52B on the side of the diaphragm 10 moves to position Z₁ by ΔZ₁ in the vibration direction of the diaphragm 10 (Z-axial direction). More specifically, the diaphragm 10 is pushed up by ΔZ₁ in the vibration direction.

As shown in FIG. 3(c), when the hinge part 52A formed at the end of the voice coil 30 moves from the original position X₀ to the position X₂ by ΔX₂ in the vibration direction (−X-axial direction), the inclination angle of the link part 51 is converted to be θ₂ (θ₀<θ₂)and the position of the hinge part 52B on the side of diaphragm 10 moves to position Z₂ by AZ₂ in the vibration direction of the diaphragm 10 (−Z-axial direction). More specifically, the diaphragm 10 is pushed down by ΔZ₂ in the vibration direction.

As such, the vibration direction converter part 50, including the link part 51 and the hinge part 52 (52A, 52B), converts vibration of the voice coil 30 to the change in the angle of the link part 51 obliquely disposed and transmits it to the diaphragm 10, and thus vibrating the diaphragm 10 in a direction different from the vibration direction of the voice coil 30.

FIG. 4 is a view illustrating another configuration example and the operation of the vibration direction converter part 50. Specifically, FIG. 4(b) shows a state of the vibration direction converter part 50 when the diaphragm 10 is positioned in a reference position, FIG. 4(a) shows a state of the vibration direction converter part 50 when the diaphragm 10 is displaced to the sound emission side from the reference position and FIG. 4(c) shows a state of the vibration direction converter part 50 when the diaphragm 10 is displaced in the direction opposite to the sound emission side from the reference position (diaphragm 10 is not shown).

The vibration direction converter part 50 has a function that the link part 51 can angle-convert by receiving reaction force from a static part 100 such as the frame 12 positioned on the opposite side of the diaphragm. Specifically, the vibration direction converter part 50 includes a first link part 51A having one end on the side of the voice coil 30 as a hinge part 52A while another end on the side of the diaphragm 10 as a hinge part 52B and a second link part 51B having one end as a hinge part 52C to the middle part of the first link part 51A while another end as a hinge part 52D to the static part 100, and the first link part 51A and the second link part 51B are obliquely disposed in different directions with respect to the vibration direction of the voice coil 30. More specifically, the vibration direction converter part 50 includes a first link part 51A having one end on the side of the voice coil 30 as a first hinge part 52A while another end on the side of the diaphragm 10 as a second hinge part 52B and a second link part 51B having one end as a third hinge part 52C to the middle part of the first link part 51A while another end as a fourth hinge part 52D to the static part 100, and the first hinge part 52A, the second hinge part 52B and the fourth hinge part 52D are located on the circumference of a circle with a diameter of substantially the same length as the first link part 51A, having the third hinge part 52C as the center.

In the vibration direction converter part 50, the hinge part 52D, supported by the static part 100 (or frame 12), is only the hinge part that does not change position, and thus providing reaction force from the static part 100 for the link part 51. Accordingly, when the voice coil 30 (or the voice coil support part 40) moves from the reference position X₀ by ΔX₁ in the X-axial direction, angles of the first link part 51A and the second link part 51B that are obliquely disposed in different directions are increased by substantially the same angle as shown in FIG. 4(a), and thus the hinge part 52B, receiving reaction force from the static part 100 at the hinge part 52D, securely pushes up the diaphragm 10 from the reference position Z₀ by ΔZ₁ in the Z-axial direction. Further, when the voice coil 30 moves from the reference position X₀ by ΔX₂ in the direction opposite to the X-axial direction, angles of the first link part 51A and the second link part 51B are decreased by substantially the same angle as shown in FIG. 4(c), and thus the hinge part 52B, receiving reaction force from the static part 100 at the hinge part 52D, securely pushes down the diaphragm 10 from the reference position Z₀ by ΔZ₂ in the direction opposite to the Z-axial direction

A length a of a link part from the hinge part 52A to the hinge part 52C, a length b of a link part from the hinge part 52C to the hinge part 52B and a length c of a link part from the hinge part 52C to the hinge part 52D are configured to be substantially the same as each other, and thereby the hinge part 52A and the hinge part 52D according to an embodiment of the present invention are arranged substantially in parallel with the moving direction of the voice coil 30. This link body is well known as a “Scott Russell linkage” where the hinge parts 52A, 52B and 52D are located on the circumference of a circle with the length of the first link part 51A (a+b=2a) as the diameter and the hinge part 52C as the center of the circle. In particular, the angle defined by the line passing through the hinge part 52A and the hinge part 52D and the line passing through the hinge part 52B and the hinge part 52D becomes a right angle. As such, when the voice coil 30 is moved in the X-axial direction, the hinge part 52B between the first link part 51A and the diaphragm 10 moves in the Z-axial direction that is perpendicular to the X-axis, and thus it is possible to convert the vibration direction of the voice coil 30 to its orthogonal direction and transmit the vibration to the diaphragm 10.

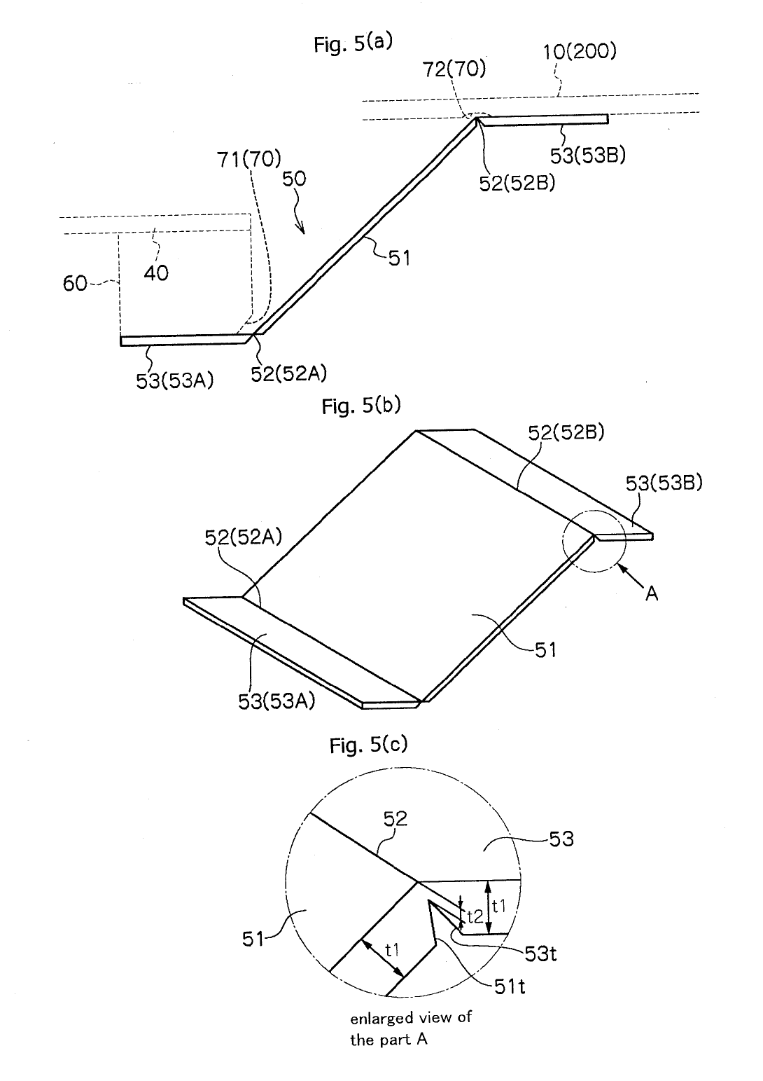

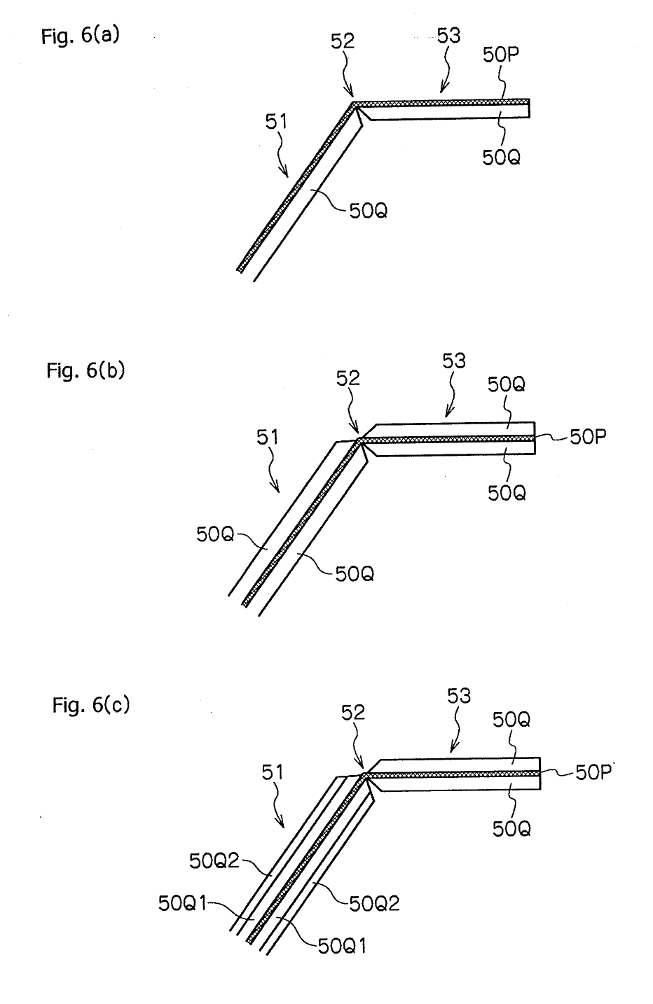

FIGS. 5 and 6 are views illustrating a formation example of the vibration direction converter part 50 (FIG. 5(a) is a side view, FIG. 5(b) is a perspective view and FIG. 5(c) is an enlarged view of part A). The vibration direction converter part 50 includes the link part 51 and the hinge parts (52A, 52B) formed at both ends of the link part 51 as described above. As shown in the drawings, connecting parts 53 (first connecting part 53A and second connecting part 53B) are formed at both ends of the link part 51 via hinge parts 52. The first connecting part 53A, connected to the voice coil 30 or the voice coil support part 40 directly or via other member, integrally vibrates with the voice coil 30, while the second connecting part 53B, connected to the diaphragm 10 directly or via other member, integrally vibrates with the diaphragm 10.

In the vibration direction converter part 50, the link part 51, the hinge parts 52A and 52B, the first and second connecting parts 53A and 53B are integrally formed, and the hinge parts 52A and 52B are formed with a bendable continuous member continuing between the parts of both sides over the hinge parts 52A and 52B. This continuous member may be a member configuring the link part 51 and the first and the second connecting part 53A and 53B as a whole, or may be a member configuring the link part 51 and a part of the first and second connecting parts 53A and 53B. Provided with this second connecting part 53B, the link part 51 may support the diaphragm 10 over a wide range, and thereby it is possible to vibrate the diaphragm 10 in the same phase. The term “fold” includes “bend” in its conceptual scope.

If the vibration direction converter part 50 is formed with a plate shape member, the hinge part 52 is linearly formed extended in a width direction as shown in FIG. 5 (b). Further, the link part 51 is required to be rigid and not to be deformable. Since the hinge part 52 is required to be bendable, the integral member is configured to have a different property by forming the thickness t2 of the hinge part 52 smaller than the thickness t1 of the link part 51 or the connecting part 53.

Further, the change in thickness of the hinge part 52 and the link part 51 is formed on a slant face, and the slant faces 51t and 53t, facing the ends of the parts of both sides over the hinge part 52, are formed. As such, when the link part 51 is angle-varied, interference to the angle variation by thickness of the link part 51 may be restrained.

Further, a recessed portion or notch part 71, which acts as a contact avoiding part 70, is formed at the end of the connecting part 60 that is an attaching counterpart 200 arranged near the hinge part 52A, such that a space is formed between the hinge part 52A and the connecting part 60 as shown in FIG. 5(a). In an example shown in FIG. 5(a), the notch part is formed in a slantwise cross-sectional shape. Furthermore, a recessed portion or notch part 72, which acts as a contact avoiding part 70, is formed at the diaphragm 10 that is an attaching counterpart 200 arranged near the hinge part 52B, such that a space is formed between the hinge part 52B and the diaphragm 10. In an example shown in FIG. 5(a), the recessed portion is formed in a curved cross-sectional shape. As such, contact between the hinge parts 52A, 52B and the attaching counterpart 200 may be restrained. Further, when joining the first connecting part 53A of the link part 51 with the end face of the connecting part 60, and joining the second connecting part 53B with the diaphragm 10 respectively with adhesive as a joining member, even if the adhesive runs off toward the hinge parts 52A, 52B, it will run into the recessed portion or the notch part 71, 72, and therefore it will not adhere to the hinge parts 52A, 52B. Since the adhesive only adheres to a non-hinge part (unbendable or unfoldable rigid part) even if the adhesive adheres, interference to bending or folding of the hinge parts 52A, 52B may be restrained.

In an example shown in FIG. 6, a link part or a connecting part is configured by integrating a bendable continuous member and a rigid member, and a hinge part is a part that is configured by the continuous member. In the example shown in FIG. 6(a), the link part 51 or the connecting part 53 is formed by joining a rigid member 50Q to the surface of a continuous member 50P that is a bendable sheet-shaped member. According to this configuration, the continuous member 50P continuously extends between the parts of both sides over the hinge part 52, and the hinge part 52 is bendably formed substantially only by the continuous member 50P. Meanwhile, the link part 51 or the connecting part 53, which is formed by joining the rigid member 50Q to the continuous member 50P, may be formed as a rigid part.

In an example shown in FIG. 6(b), the rigid members 50Q are applied to sandwich the continuous member 50P to form the link part 51 or the connecting part 53. Also, the part, not applied with the rigid member 50Q, becomes the hinge part 52. In an example shown in FIG. 6(c), the rigid member forming the link part 51 is formed in multiple layers laminated by the rigid members 50Q1 and 50Q2. Further, in FIG. 6(c), the rigid member 50Q1 and the rigid member 50Q2 may be formed in a multiple-layer structure. As such, the bendable hinge part 52 and the rigid link part 51 and connecting part 53 may be integrally formed by partially joining the rigid member 50Q to the bendable continuous member 50P.

According to one or more embodiments of the present invention, the continuous member 50P has intensity and durability to the extent that it can withstand the bending of the hinge 52 that is repeated when the speaker device is driven and has flexibility to the extent that it does not make sound when the bending action is repeated. Specifically, the continuous member 50P can be formed with fabric or unwoven fabric which are made of high-intensity fiber. As examples of the fabric, plain weave fabric with uniform material, plain weave fabric with warp and well threads made of different materials respectively, plain weave fabric with alternately changed thread materials, plain weave fabrics with twisted union yarn and plain weave fabrics by basket weaving, and so forth, may be included. And, triaxial woven fabrics, multi-axial woven fabrics, triaxial and multiaxial “SOF”, knit and one directional basket woven fabrics, etc may be included other than plain weave fabric.

When the high-intensity fiber is applied partially or as a whole, sufficient intensity against vibration of the voice coils 30 or the voice coil support part 40 may be achieved by arranging the high-intensity fiber in the vibration direction of the voice coil support part 40. When both the warp and the weft threads are high-intensity fibers, durability may be improved with a uniform tensile force applied to the warp and the weft threads by inclining both fiber directions by 45° with respect to the vibration direction of the voice coil support part 40. As the high-intensity fiber, aramid fiber, carbon fiber, glass fiber, etc. may be used. Further, a damping material may be applied to adjust physicality such as bending stress or rigidity of the continuous member.

As the rigid member 50Q, thermoplastic resin, thermosetting resin, metal, paper, etc., which are light weight, easy to mold and having rigidity after hardening, may be used, according to one or more embodiments of the present invention. The vibration direction converter part 50 may be formed by joining the rigid member 50Q, which is molded in a plate shape, to the surface of the continuous member 50P other than the part of the hinge part 52 by using adhesive as a joining material. Further, if thermosetting resin is used as the rigid member 50Q, the vibration direction converter part 50 may be formed by impregnating partially the link part 51 or the connecting part 53 of the fibrous continuous member 50P with resin and then hardening it. Further, if resin or metal is used as the rigid member 50Q, the continuous member 50P and the rigid member 50Q may be integrated at the link part 51 and the connecting part 53 by using insert molding. The above-mentioned technology concerning the integral forming is described in US20050127233 (Publication No. US2005/253298) filed in the US on May 12, 2005 and US20050128232 (Publication No. US2005/253299) filed in the US on May 13, 2005, which is incorporated here in the present application.

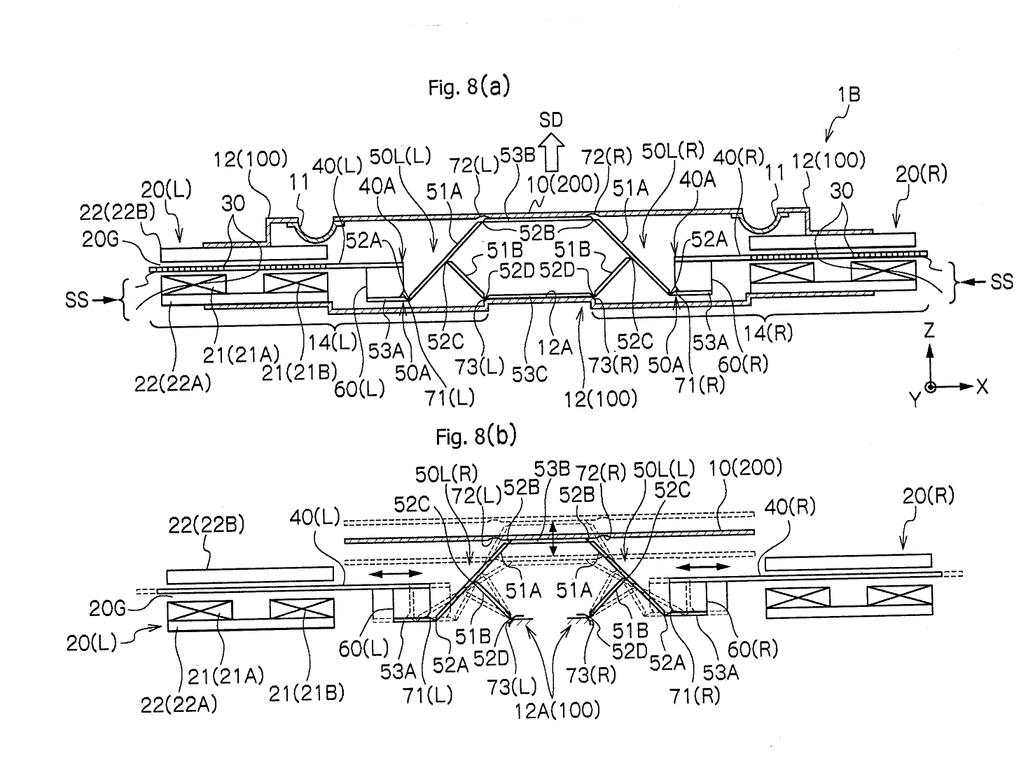

FIGS. 7 and 8 are views illustrating a speaker device adopting the above-mentioned vibration direction converter part (FIGS. 7(a) and 8(a) are cross-sectional views taken in X-axial direction and FIGS. 7(b) and 8(b) are views illustrating an operation of the driving part). The same symbols are applied to the same parts and a part of duplicate descriptions is eliminated. In a speaker device 1A, 1B shown in FIGS. 7 and 8, a link body 50L is formed to include the first connecting part 53A that is connected to the voice coil support part 40 and vibrates integrally with the voice coil support part 40 and the second connecting part 53B that is connected to the diaphragm 10 and vibrates integrally with the diaphragm 10 as well as a plurality of link parts.

In the speaker device 1A shown in FIG. 7, the vibration direction converter part 50 is formed with the link body 50L including the rigid first link part 51A and second link part 51B. The first connecting part 53A is formed at one end of the first link part 51A via the hinge part 52A while the second connecting part 53B is formed at another end of the first link part 51A via the hinge part 52B. The middle part of the first link part 51A is formed at one end of the second link part 51B via the hinge part 52C while the connecting part 53C, which is static with respect to vibration of the voice coil support part 40, is formed at another end of the second link part 51B via the hinge part 52D.

According to the drawings, the first connecting part 53A is connected to the end of the voice coil support part 40 directly or via the connecting part 60, the second connecting part 53B is directly connected to the diaphragm 10 and the static connecting part 53C is connected to the bottom portion 12A of the frame 12 that is the static part 100. A recessed portion or a notch part 73, which acts as a contact avoiding part 70, is formed at the bottom portion 12A of the frame 12 that is an attaching counterpart 200 arranged near the hinge part 52D, such that a space is formed between the hinge part 52D and the bottom portion 12A of the frame 12. In an example shown in the drawings, the notch part is formed. The first link part 51A and the second link part 51B are obliquely disposed in different directions with respect to the vibration direction (X-axial direction) of the voice coil support part 40 and the static part 100 is provided on the opposite side of the diaphragm 10 with respect to the vibration direction converter part 50. In the example shown in the drawings, although the static part 100 is formed with the bottom portion 12A of the frame 12, a yoke 22A of a magnetic circuit 20 may be the static part 100 instead of the bottom portion 12A of the frame 12 by extending the yoke 22A of the magnetic circuit 20 to the position under the vibration direction converter part 50.

As shown in FIG. 7(b), the hinge part 52A on the side of the voice coil support part 40 moves in the X-axial direction in accordance with the movement of the voice coil support part 40 while the hinge part 52D connected to the static part 100 is fixed. The movement of the hinge part 52A is converted to changing angles of the first link part 51A and the second link part 51B, and thus the hinge part 52B on the side of the diaphragm 10 is moved in the vibration direction of the diaphragm 10 (for example, Z-axial direction).

The speaker device 1B shown in FIG. 8 is configured with the driving parts 14 shown in FIG. 7 symmetrically disposed opposite to each other, which includes the driving parts 14(R) and 14(L), respectively. Each of the driving parts 14(R) and 14(L) includes a link body 50L(R) or 50L(L), a voice coil support part 40(R) or 40(L), a magnetic circuit 20(R) or 20(L) and a connecting part 60(R) or 60(L).

The link bodies 50L(R) and 50L(L) configure the vibration direction converter part 50 such that a pair of the first link parts 51A, a pair of the second link parts 51B, a pair of the first connecting parts 53A, the second connecting part 53B and the static connecting part 53C, which are disposed opposite to each other, are integrally formed. A pair of the first connecting parts 53A are connected to the voice coil support part 40 respectively, the second connecting part 53B is connected to the diaphragm 10, and the static connecting part 53C is connected to the bottom portion 12A of the frame 12.

As shown in FIG. 8(b), the diaphragm 10 may be driven by two combined driving forces of the driving parts 14(R) and 14(L) by setting the vibration directions of the voice coil support part 40(R) and 40(L) synchronously opposite to each other. Further, since a plurality of hinge parts 52B are provided on the side of the diaphragm 10, the number of support points on the diaphragm 10 is increased, thereby the phase of vibration of the diaphragm 10 may become uniform.

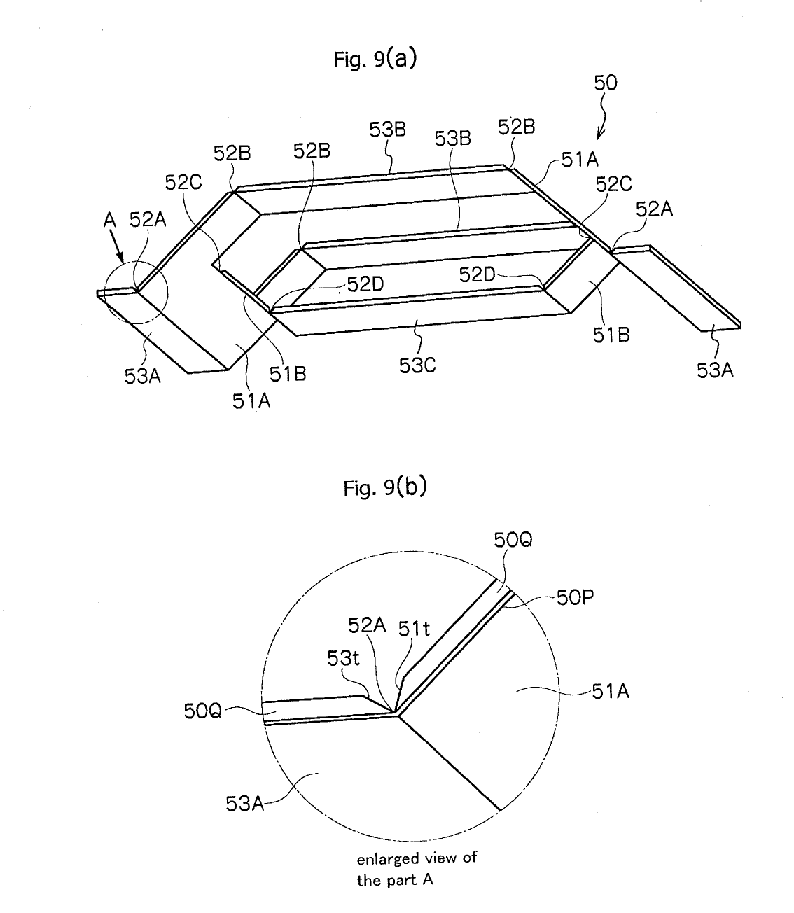

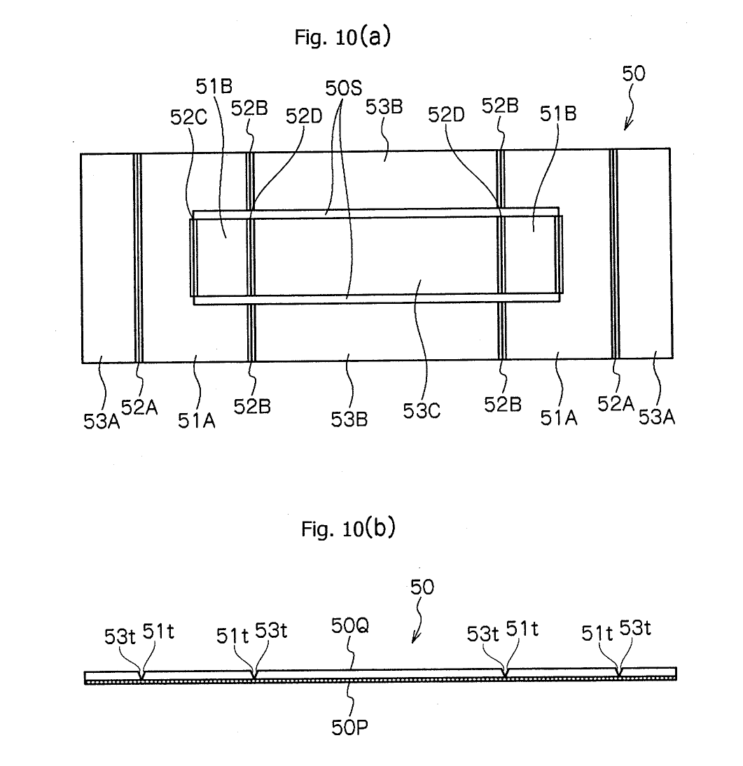

FIGS. 9 and 10 are views illustrating more specific vibration direction converter part (FIG. 9(a) is a perspective view, FIG. 9(b) is an enlarged view of part A in FIG. 9(a), FIG. 10(a) is a plan view illustrating a flattened whole part by unfolding the vibration direction converter part and FIG. 10(b) is a side view illustrating a flattened whole part by unfolding the vibration direction converter part. In this example, the vibration direction converter part 50 is formed with a single integrated component. As described above, the vibration direction converter part 50 is formed with a pair of the first link parts 51A, hinge parts 52A and 52B formed at both ends of the first link parts 51A, a pair of the second link parts 51B and hinge parts 52C and 52D formed at both ends of the second link parts 51B. Further, the first connecting parts 53A are formed at one ends of a pair of the first link parts 51A via the hinge parts 52A, the second connecting part 53B is formed between hinge parts 52B formed at other ends of a pair of the first link parts 51A and the static connecting part 53C is formed between the hinge parts 52D formed at other ends of the second link parts 51B. The first link parts 51A, 51A and the second connecting part 53B are bent in a protruding shape and the second link parts 51B, 51B and the static connecting part 53C are bent in a recessed shape.

As shown in FIG. 9(b), the hinge part 52A is bendably formed with the above continuous member 50P. The above rigid member 50Q is attached to the first link part 51A and also to the first connecting part 53A. Also, the first connecting part 53A is joined by the above rigid member 50Q. As such, all of the above-mentioned hinge parts are formed in the similar configuration. Further, slant faces 51t and 53t are formed opposite to each other in each hinge part.

As shown in FIG. 10(a), the vibration direction converter part 50, including the link parts 51A, 51B, each hinge part and the connecting part 53A, 53B, 53C, is formed with an integral sheet-shaped member. The hinge parts 52A are formed linearly crossing the integral sheet-shaped member, while the hinge parts 52B, 52C, 52D are formed partially crossing the integral sheet-shaped member. A pair of notch parts 50S are formed in a longitudinal direction of the integral sheet-shaped member such that the second link parts 51B, 51B and the static connecting part 53C are cut out and formed.

As shown in FIG. 10(b), the vibration direction converter part 50 is formed, for example, by applying resin material forming the rigid member 50Q to the whole surface of the continuous member 50P that is a sheet-shaped member, such that the resin material is laminated on the continuous member 50P, and cutting in a V-shape to form each hinge part and the slant faces 51t and 53t at both sides thereof. After that, the above-mentioned notch part 50S is formed and the resin material is hardened. A liquid unhardened resin material or resin film may be used as the resin material used in this embodiment.

Further, each hinge part and the slant faces 51t and 53t at both sides thereof may be formed at the same time as forming the rigid member 50Q with the resin material. According to one or more embodiments of the present invention, a cross-sectional V-shape groove or a recessed portion is formed preliminarily in a die, which is used to mold the rigid member 50Q.

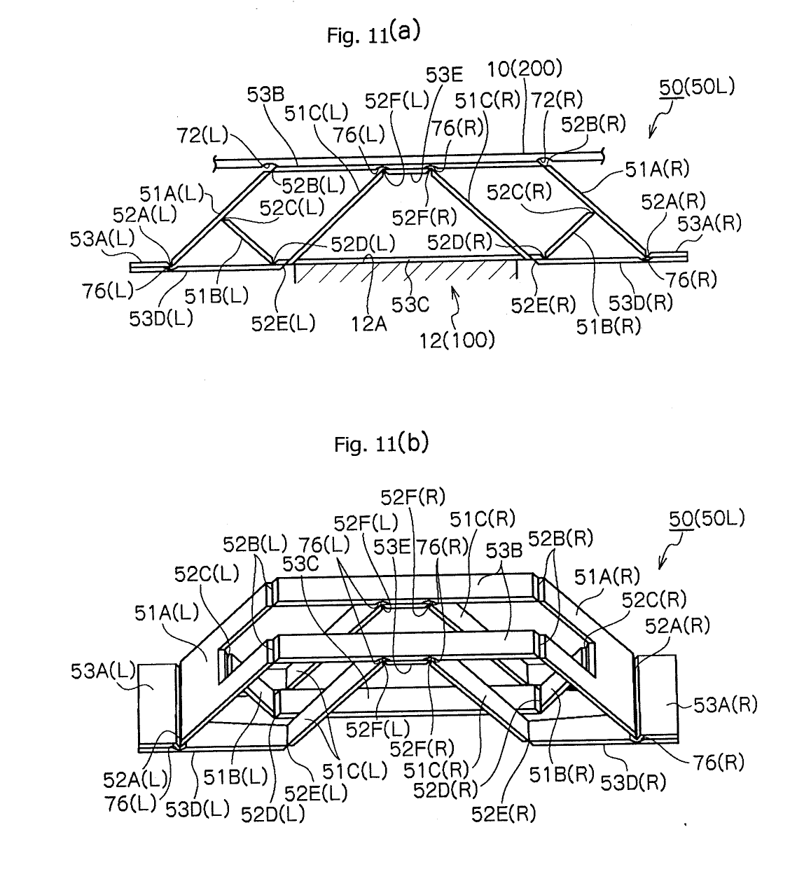

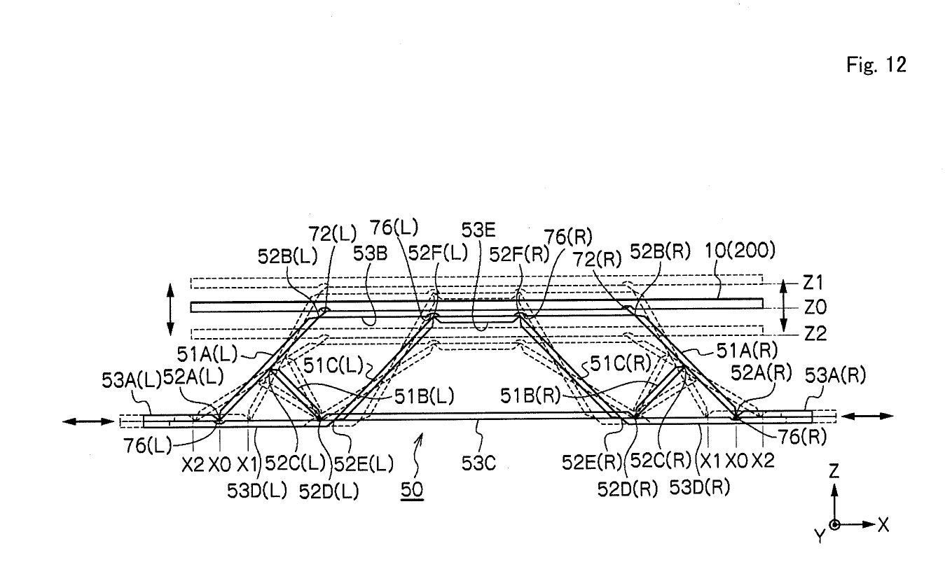

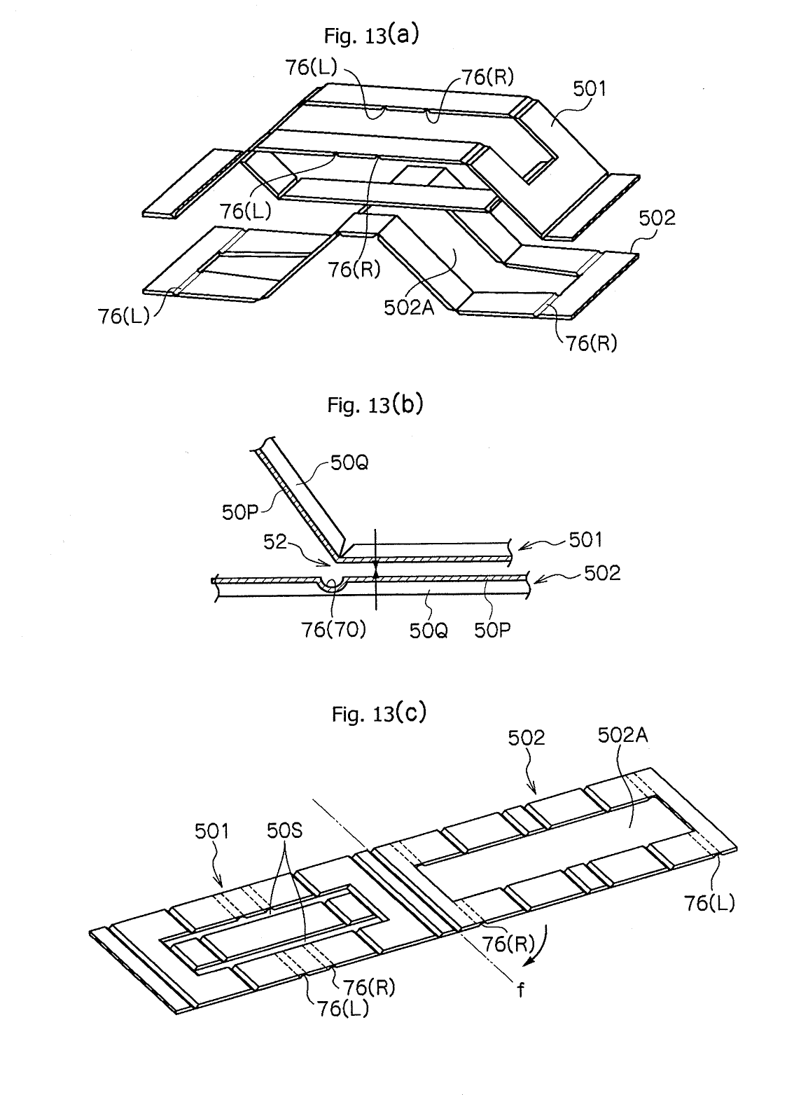

FIGS. 11, 12 and 13 are views illustrating other examples of the vibration direction converter part 50 (FIG. 11(a) is a side view, FIG. 11(b) is a perspective view, FIG. 12 is a view illustrating an operation and FIGS. 13(a) and 13(b) are views illustrating formation examples). The vibration direction converter part 50 (link body 50L) includes a pair of driving parts. In this embodiment, the vibration direction converter parts 50 are substantially symmetrically disposed opposite to each other and a parallel link is formed with a plurality of link parts.

The vibration direction converter part 50 includes a pair of first link parts 51A(R) and 51A(L) having a hinge part 52A(R) and 52A(L) to a first connecting part 53A (R) and 53A (L) at one end, and having a hinge part 52B(R) and 52B(L) to a second connecting part 53B at another end. Also, the vibration direction converter part 50 includes a pair of second link parts 51B(R) and 51B(L) having hinge parts 52C(R) and 52C(L) to the middle parts of the first link parts 51A(R) and 51A(L) at one end, and having hinge parts 52D(R) and 52D(L) to the static connecting part 53C at another end. As described above, the first connecting part 53A is connected to the voice coil 30 or the voice coil support part 40 directly or via the connecting part 60 as other member, while the second connecting part 53B is connected to the diaphragm 10 and the static connecting part 53C is connected to the bottom portion 12A of the frame 12 that is the static part 100, the yoke 22, etc. forming the magnetic circuit 20.

Further the vibration direction converter part 50 includes a pair of third link parts 51C(R) and 51C(L) having hinge parts 52E(R) and 52E(L) at one end to a pair of the connecting parts 53D(R) and 53D(L) integrally extending from the first connecting part 53A (R) and 53A (L), and having hinge parts 52F (R) and 52F (L) at another end to a connecting part 53E that is integral with the second connecting part 53B.

Further, the first link part 51A(R) and the third link part 51C(R), the first link part 51A(L) and the third link part 51C(L), the second link part 51B(R) and the third link part 51C(L), and the second link part 51B(L) and the third link part 51C(R) form parallel links respectively.

This link body 50L of the vibration direction converter part 50 substantially includes a function combining the link body of the embodiment shown in FIG. 7 and the parallel link body. Each link part and connecting part are formed by integrating the continuous member 50P with the rigid member 50Q, while each hinge part between link parts is linearly formed with the bendable continuous member 50P, and thus link parts are mutually integrally formed via hinge parts.

As shown in the drawings, the second connecting part 53B arranged near the hinge parts 52F (R) and 52F (L) and a pair of the connecting part 53D(R) and 53D(L) arranged near the hinge parts 52A(R) and 52A(L) form recessed portions 76 as the contact avoiding part 70, such that a space is formed between each hinge part and connecting part.

An operation of the vibration direction converter part 50 is described with reference to FIG. 12. In this embodiment, the static connecting part 53C functions as the static part 100. According to the vibration direction converter part 50, when the hinge parts 52A(R) and 52A(L) are moved from the reference position X0 to X1 in the X-axial direction in accordance with vibration of the voice coil support part 40, the second connecting part 53B and the connecting part 53E integrally with the second connecting part 53B moving up keeping a parallel state by the parallel link body, while the first link parts 51A(R) and 51A(L) and the third link parts 51C(R) and 51C(L), which configure a parallel link, are angle-varied as they are erected. Since the hinge parts 52D(R) and 52D(L) are supported at both ends of the static connecting part 53C as the static part, they receive a reaction force from the static part and angle of the first link parts 51A(R) and 51A(L) and the third link parts 51C(R) and 51C(L) is securely varied and the displacement of the hinge parts 52A(R) and 52A(L) from the position X0 to X1 is securely converted to the displacement of the diaphragm 10 from the position Z0 to Z1.

Similarly, when the hinge parts 52A(R) and 52A(L) is moved from the reference position X0 to X2 in the X-axial direction, the second connecting part 53B and the connecting part 53E integrally with the second connecting part 53B are moved down keeping a parallel state by the parallel link body, while angles of the first link parts 51A(R) and 51A(L) and the third link parts 51C(R) and 51C(L), which form a parallel link, are varied as they are laid. Since the hinge parts 52D(R) and 52D(L) are supported by the static part, they receives a reaction force from the static part and angle variation of the first link parts 51A(R) and 51A(L) and the third link parts 51C(R) and 51C(L) is securely produced and the displacement of the hinge parts 52A(R) and 52A(L) from the position X0 to X2 is securely converted to the displacement of the diaphragm 10 from the position Z0 to Z2.

According to this vibration direction converter part 50, the vibration in the X-axial direction of one voice coil support part 40 is converted to the vibrations in the Z-axial direction of the hinge parts 52B(R) and 52B(L), 52F (R) and 52F (L), and the second connecting part 53B, which vibrate substantially in the same phase and the same amplitude. As such, since the diaphragm 10 is supported over a large area and given the vibration that has substantially the same phase and the same amplitude, the vibration of the voice coil support part 40 may be transmitted substantially in the same phase to the planar diaphragm 10 with large area.

As shown in FIG. 11 (b), in the vibration direction converter part 50, a pair of the connecting parts 53B, 53D(R) and 53D(L) and the third link parts 51C(R) and 51C(L) are disposed in a width direction and parallel respectively. The first link parts 51A(R) and 51A(L) are formed in a biforked shape, and the hinge parts 52C(R) and 52C(L) to the second link parts 51B(R) and 51B(L) are formed at the middle parts of the first link parts 51A(R) and 51A(L). The second link parts 51 B(R) and 51 B(L) and the connecting part 53C are placed between a pair of the connecting parts 53B, 53D(R) and 53D(L) and the third link parts 51C(R) and 51C(L), which are disposed in a width direction and parallel.

With link parts formed with a single sheet-shape component as described above, the diaphragm 10 can be vibrated and supported by a face, and thereby the whole diaphragm 10 can be vibrated substantially in the same phase and divided vibration may be restrained.

Further, as shown in FIG. 11(b), in the vibration direction converter part 50 of this embodiment, the first link parts 51A(R) and 51A(L), and the second connecting parts 53B are formed by folding the whole single sheet-shape component forming the link parts in a protruding-trapezoid shape, while the second link parts 51B(R) and 51B(L), and the static connecting part 53C are formed by folding a partially taken-out portion of this plate component.

A method of forming this vibration direction converter part 50 is described with reference to FIG. 13. According to one configuration method, this vibration direction converter part 50 is formed by joining a plurality of sheet-shape components 501, 502 (for example, two components) as shown in FIG. 13(a). The first connecting parts 53A(R) and 53A(L), the first link parts 51A(R) and 51A(L), the second link parts 51B(R) and 51B(L), the second connecting parts 53B and the static connecting part 53C are formed in one sheet-shape component 501, while the connecting parts 53D, the third link parts 51C(R) and 51C(L) and the connecting parts 53E are formed in another sheet-shape component 502. And, the third link parts 51C(R) and 51C(L) and the connecting parts 53D(R) and 53D(L) are formed along the first link parts 51A(R) and 51A(L) and the second connecting parts 53B, and an opening 502A is formed in the sheet-shape component 502 corresponding to the second link parts 51B(R) and 51B(L) and the static connecting part 53C.

In this embodiment, the opening 502A, formed in another sheet-shape component 502 corresponding to the second link parts 51B(R) and 51B(L) and the static connecting part 53C of one sheet-shape component 501, is formed so as to expand inward from ends of another sheet-shape component 502. This configuration may prevent the second link parts 51B(R) and 51B(L), and the static connecting part 53C from contacting another sheet-shape component 502, and thus a smooth movement of the link body may be performed.

The two sheet-shape components 501 and 502, which are formed with the continuous member 50P and the rigid member 50Q, are applied with their continuous members 50P, 50P face-to-face as shown in FIG. 13(b). According to this arrangement, the continuous members 50P, 50P are integrated, and thereby hinge parts 52 may smoothly bend. Also in this case, the recessed portion or the notch part 76 is formed as the contact avoiding part 70 near the hinge part 52.

Further, the slant face as shown in FIG. 5(c) is formed at the end of each link part near each hinge part. The slant face is formed such that the link parts do not interfere with each other when they bend at the hinge parts. Thus the link parts can efficiently bend at the hinge parts.

In another forming example, the above-mentioned sheet-shape component 501 and the sheet-shape component 502 are integrally formed with the sheet-shape component 502 connected to the end of the sheet-shape component 501 as shown in FIG. 13(c). The vibration direction converter parts 50 shown in FIGS. 11 and 12 may be obtained by folding the integrated components along a folding line fin the direction of an arrow. In this example, the vibration direction converter part 50 may be simply configured by applying resin material forming the rigid member 50Q to the whole surface of the continuous member 50P that is a sheet-shaped member, cutting in a V-shape to form each hinge part and the slant faces at both sides thereof, and then forming the above-mentioned notch part 50S and opening 502A and hardening the resin material in the same way as shown in FIG. 10.

Further, when forming each hinge part and the slant faces 51t and 53t at the both sides thereof, the rigid member 50Q may be formed with the resin material and molded at the same time. According to one or more embodiments of the present invention, a cross-sectional V-shape groove or a recessed portion is preliminarily formed in a die, which is used to mold the rigid member 50Q.

In the vibration direction converter part 50 shown in FIGS. 8 to 13, since the link body of the vibration direction converter part 50 may be formed with a single integral component with respect to two opposing voice coil support parts 40, the assembly operation may be simplified as well when forming a speaker device provided with a pair of driving parts. Further, provided with the static connecting part 53C, the hinge parts 52D(R) and 52D(L) may be held at fixed positions even if they are not particularly supported by the frame 12 corresponding to opposing vibrations of the voice coil support parts 40 (a plurality of the voice coil support parts 40 vibrate in directions opposite to each other), and thus the vibration direction converter part may be simply built into a speaker device.

Further, in the vibration direction converter part 50 shown in FIGS. 11 to 13, since the right side first link part 51A(R) and the third link parts 51C(R), and the left side first link part 51A(L) and the third link parts 51C(L) form parallel links as the link body, the second connecting parts 53B fixed to the diaphragm 10 may be stably moved in parallel in the Z-axial direction corresponding to the opposing vibrations of the voice coil supporting parts 40. Accordingly, it is possible to apply stable vibrations to the planar diaphragm 10.

According to this speaker device 1, 1A and 1B, when an audio signal SS is inputted, the voice coil support part 40 vibrates along the magnetic gap 20G formed in a direction different from the vibration direction admissible for the diaphragm 10, and this vibration is direction-converted by the vibration direction converter part 50 and transmitted to the diaphragm 10, and thereby vibrating the diaphragm 10 to emit a sound in the sound emission direction SD corresponding to the audio signal SS.

Since the direction of the magnetic gap 20G is configured to cross the vibration direction of the diaphragm 10 and the thickness direction of the speaker device 1, 1A and 1B, increasing the driving force of the magnetic circuit 20 or the vibration of the voice coil 30 does not directly affect the size of the speaker device 1, 1A and 1B in the thickness direction (Z-axial direction). Accordingly, it is possible to make the speaker device 1, 1A and 1B thin while pursuing making a louder sound.

Further, since the vibration direction converter part 50 converts the vibration direction of the voice coil support part 40 and transmits the vibration to the diaphragm 10 through the mechanical link body, transmission efficiency of vibration is high. In particular, in the speaker device 1A and 1B shown in FIGS. 7 to 8, since angle variation of the first link parts 51A and the second link parts 51B is produced by the vibration of the voice coil support part 40 and reaction force of the static part 100, vibration of the voice coil support part 40 may be more securely transmitted to the diaphragm 100. Accordingly, the speaker device 1A and 1B may produce preferable reproducing efficiency.

Further, in the speaker device 1, 1A and 1B shown in FIGS. 2, 7, and 8, provided with the connecting part 60, step (interval) in the Z-axial direction may be formed between the position of the end 40A of the voice coil support part 40 and the position of the end 50A of the vibration direction converter part 50. As such, the width (height) in the Z-axial direction of the magnetic circuit 20 can be included in the length in the Z-axial direction of the vibration direction converter part 50, and thus the speaker device 1, 1A and 1B may be made thin while securing a sufficient length in the Z-axial direction for the magnetic circuit 20, which is required to secure a driving force. Further, provided with the connecting part 60, a necessary length of the direction converter part 50 (length of link parts 51) may be sufficiently secured even if the speaker device 1, 1A and 1B is made thin, and thus the amplitude of vibration of the diaphragm 10 may be comparatively large.

More particularly, a bottom portion 61 of the connecting part 60 is formed to slide over the bottom portion 12A of the frame 12 or the static part 100 with a predetermined distance therefrom, and thereby vibration of the voice coil support part 40 may be stabilized. Further, the end of the vibration direction converter part 50 can be linearly moved, and thus the end of the vibration direction converter part 50 connected to the diaphragm 10 can be securely and stably moved.

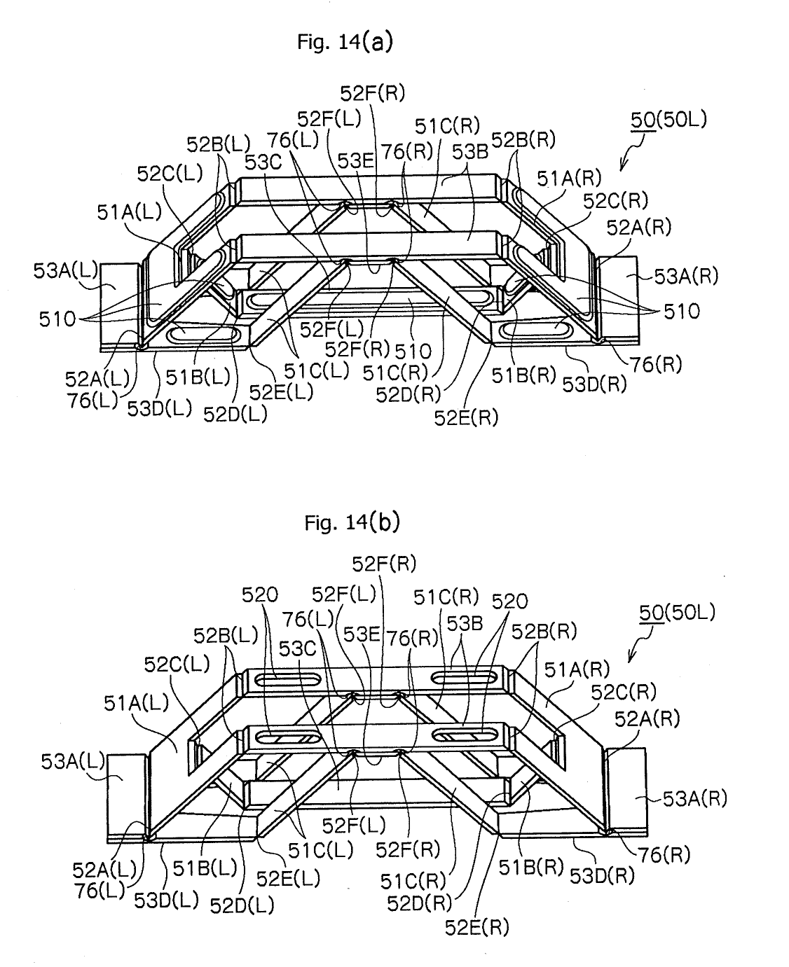

The vibration direction converter part 50 shown in FIG. 14 is a modified example of the embodiment shown in FIG. 11. In one example shown in FIG. 14(a), a protrusion portion 510 is provided on the link part that are subject to bend by opposing vibrations of the voice coil supporting parts 40, thereby rigidity of the link part can be increased. As shown in the drawing, the first link part 51A(R) and 51A(L), the second link parts 51B(R) and 51B(L), the connecting parts 53D(R) and 53D(L) and the connecting part 53C are provided with the protrusion portion 510 respectively. Further, in one example shown in FIG. 14(b), openings 520 are provided in the link part that need no particular strength, weight of the vibration direction converter part can be decreased. In the drawing, the connecting part 53B includes the openings 520. The weight reduction of the vibration direction converter part is effective to broaden a reproduction characteristic or increase amplitude and a sound pressure level of a sound wave corresponding to predetermined voice currents.

### [Static Part (Frame Structure)]

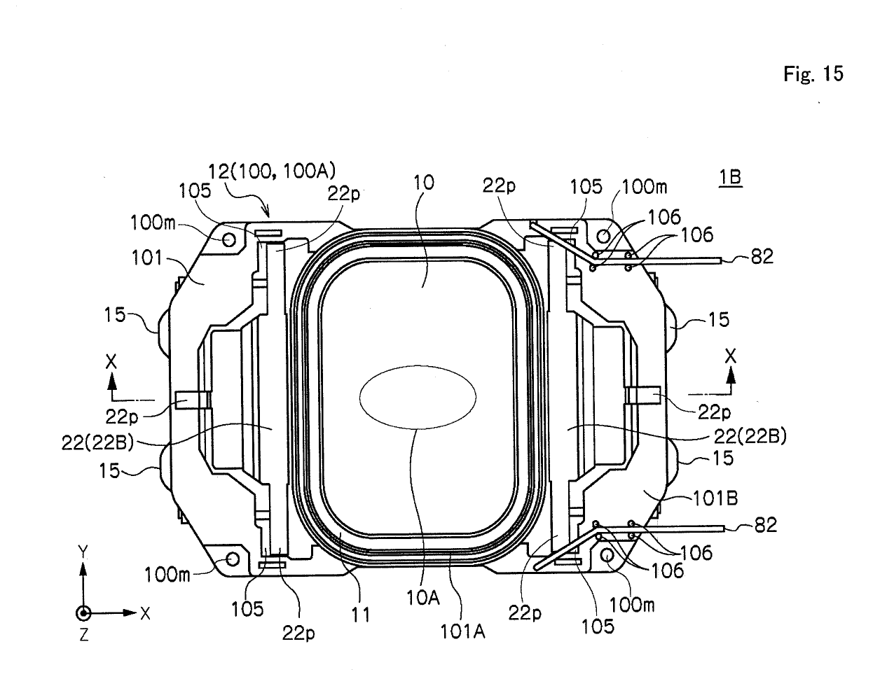

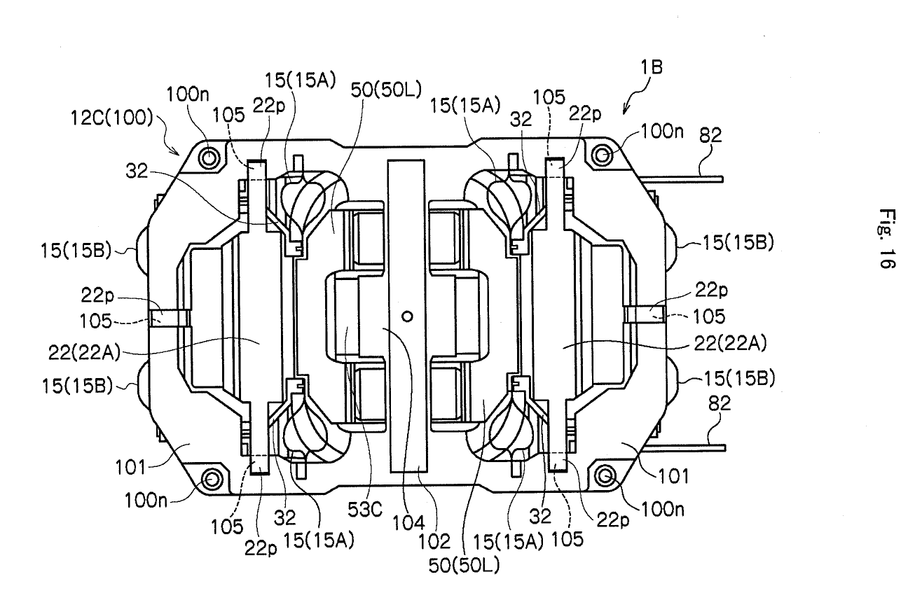

FIGS. 15 to 18 are views illustrating an example of configuring the static part in a speaker device according to an embodiment of the present invention. FIG. 15 shows a plan view of a speaker device and FIG. 16 shows a rear view of the speaker device. Hereinafter, a specific structure of the static part 100 is described referring to a speaker device 1B shown in FIG. 8 as a basic configuration.

As described above, the static part 100 is formed by the frame 12. The static part 100 includes an outer peripheral frame part 101 surrounding the diaphragm 10, and a bridge part 102 bridging the inside of the outer peripheral frame part 101, and the bridge part 102 applies a reaction force to the above-mentioned link body 50L (vibration direction converter part 50) while having rigidity in the vibration direction of the link body 50L.

As described above, the voice coil 30 vibrates and the vibration is transmitted to the diaphragm 10 via the link body 50L, when the link body 50L which angle-converts the link part 51, receives a reaction force from the diaphragm 10. When the link body 50L receives such a reaction force, if the static part 100 supporting the link body 50L bends, the link body 50L itself vibrates, thereby transmitting unwanted vibration to the link part 51. If the vibration transmitted to the link part 51 is transmitted to the diaphragm 10, the vibration from the voice coil 30 cannot be efficiently transmitted to the diaphragm 10. Here, by adding a function of preventing the deflection to a bridge part 102 which is a part of the static part 100 supporting the link body 50L, unwanted vibration can be prevented from being transmitted to the link part and the diaphragm 10. As such, the vibration of the voice coil 30 is efficiently transmitted to the diaphragm 10.

The static part 100 is provided with a first component member (first frame) 100A and a second component member (second frame) 100B. The first component member 100A is a supporting member on the sound emission side of a speaker device 1B, and the second component member 100B is a supporting member on the side opposite to the sound emission side (rear face side). The driving part 14 of the speaker device 1 is supported and sandwiched between the first component member 100A and the second component member 100B.

The first component member 100A is provided with an outer peripheral frame part 101 formed in an annular shape, supporting the outer periphery of the diaphragm 10 via an edge 11, while supporting one side (22B) of the magnetic pole member (yoke part) 22 of the magnetic circuit 20. Meanwhile, the second component member 100B is provided with the outer peripheral frame part 101 and the bridge part 102, supporting one side (22A) of the magnetic pole member (yoke part) 22 of the magnetic circuit 20, while the bridge part 102 supports the link body 50L. Here, the bridge part 102 has rigidity against the force received from the diaphragm 10 via the link body 50L. For this purpose, according to one or more embodiments of the present invention, the compliance of the bridge part 102 is substantially same or smaller than the compliance of the outer peripheral frame part 101 in the vibration direction of the diaphragm 10. More specifically, according to one or more embodiments of the present invention the thickness in the bridge part 102 is substantially same or greater than the thickness of the diaphragm 10 or the thickness in a part of the static part 100 supporting the magnetic circuit 20.

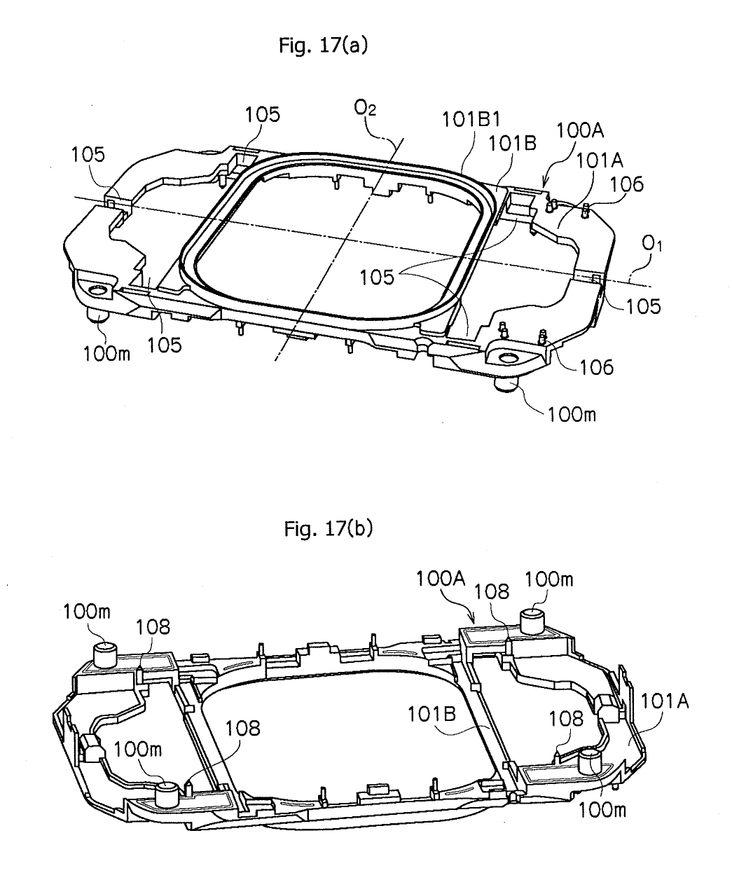

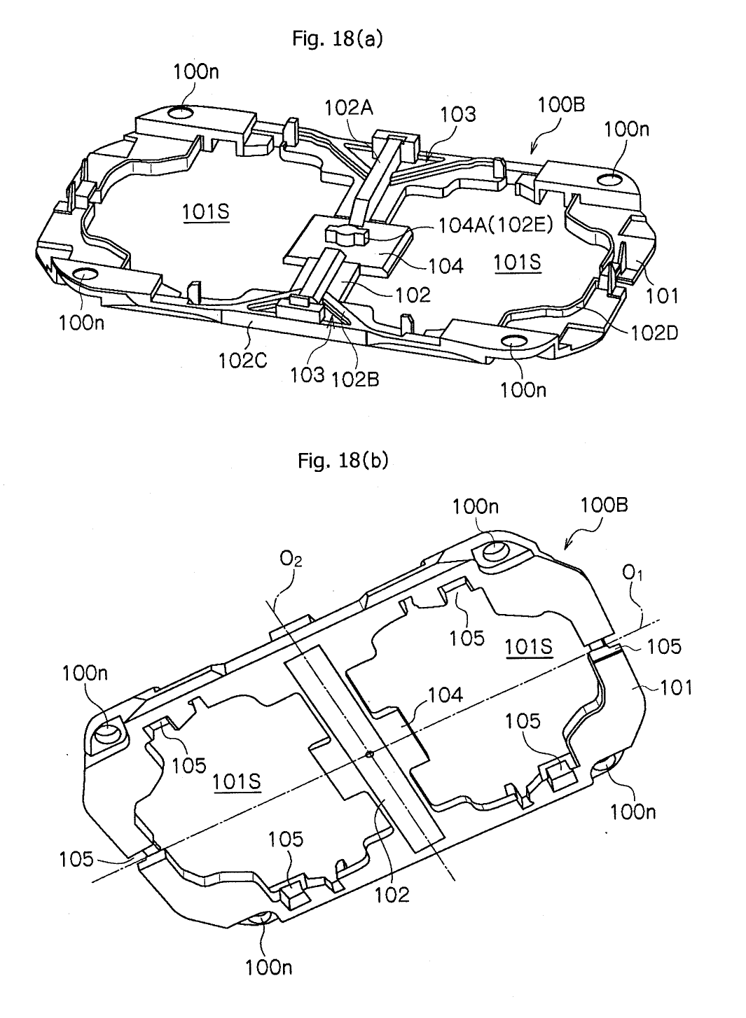

FIGS. 17 and 18 are perspective views illustrating the respective structures of the first component member 100A and the second component member 100 B (FIG. 17(a) is a plan perspective view of the first component member 100A, FIG. 17(b) is a rear perspective view of the same, FIG. 18(a) is a plan perspective view of the second component member 100B, and FIG. 18(b) is a rear perspective view of the same). The first component member 100A has the outer peripheral frame part 101 of the static part 100 as a first outer peripheral frame part 101A and has the second outer peripheral frame part 101B inside the first outer peripheral frame part 101A, supporting the diaphragm 10. The opening inside the second outer periphery part 101B is covered by the edge 11 and the diaphragm 10.

The bridge part 102 provided at the second component member 100B has a first projection part 102A formed in an extending direction of the bridge part 102, projecting toward the vibration direction of the diaphragm 10. The first projection part 102A has a rib structure formed in a longitudinal direction of the bridge part 102, which increases the bending rigidity of the bridge part 102. Further, a second projection part 102B is formed extending in a direction crossing the first projection part 102A within the face of the bridge part 102 opposite the diaphragm 10. The second projection part 102B serves as a reinforcement rib at both end parts of the bridge part 102, rigiditly supporting the bridge part 102 on the outer peripheral frame part 101 at both ends thereof.

Further, a third projection part 102C is formed extending in a direction crossing the first projection part 102A and the second projection part 102B within the face of the static part 100 opposite the diaphragm 10, and a reinforcing part 103 that has a polygonal plane shape is formed by a plurality of the second projection parts 102B and the third projection parts 102C.

The first component member 100A and the second component member 100E which constitute the static part 100 has a plane shape with a long axis O₁ and short axis O₂, and the bridge part 102 is formed in a direction of the short axis O₂. Further, the bridge part 102 can be formed in a direction of the long axis O₁ or both in a direction of the long axis O₁ and in a direction of the short axis O₂.

The first component member 100A has projection parts 100m formed at the four corners thereof, and the second component member 100B has recessed parts 100n formed at the four corners thereof, and the projection parts 100m and the recessed parts 100n fit into each other to connect the first component member 100A with the second component member 100B. The projection parts 100m may be formed at one of the first component member 100A and the second component member 100B, and the recessed parts 100n may be formed at the other of the first component member 100A and the second component member 100B. The recessed part 100n may be formed as through hole.

A protrusion part 101B1 projecting toward a sound emission direction is formed at the second outer peripheral frame part 101B supporting the diaphragm 10 via the edge 11. The protrusion part 101B1 produces rigidity for supporting the periphery of the diaphragm 10.

The magnetic circuit 20 comprising, two magnetic pole members (yoke parts) 22 having different magnetic poles each other are arranged in two spaces defined by the voice coil 30, and the magnetic pole members (yoke parts) 22 are supported by the first component member 100A and the second component member 100B. The first component member 100A and the second component member 100B are provided with recessed shaped receiving parts 105 housing a part of the magnetic pole members (yoke parts) 22. The receiving parts 105 position the magnetic pole members (yoke parts) 22 in order to form an appropriate magnetic gap.

A guiding part 106 for guiding a lead wire 82 which inputs an audio signal into the voice coil 360 from the outside is formed on the side face of the first component member 100A. Further, opening parts 101 S are formed between the outer peripheral frame part 101 and the bridge part 102 in the second component member 100B. A fourth protrusion part 102D is formed at the outer peripheral frame part 101 along the outer periphery of the opening part 101S. The fourth protrusion part 102D increases the torsional rigidity of the outer peripheral frame part 101.

Further, the first component member 100A has a plurality of projection parts that project toward the voice coil 30. The projection parts are formed as excessive-vibration restraining parts 108 for restraining the excessive-vibration of the voice coil 30. Further, a notch part 41f is formed at the end edges of the voice coil 30 in the vibration direction of the voice coil 30. The excessive-vibration restraining part 108 is arranged in the notch part 41f, and thus the width of the notch part 41f in the vibration direction of the voice coil 30 substantially corresponds to the amplitude of vibration of the voice coil 30. When the voice coil 30 excessively vibrates, the excessive-vibration restraining part 108 hits the base 41 of the voice coil support part 40, thereby the excessive-vibration of the voice coil 30 can be suppressed. In the example of the drawing, the excessive-vibration restraining part 108 is configured by the protrusion part of the first component member 100A, however, it may be provided in the second component member 100B. The excessive-vibration restraining part 108 is not limited to this example. For example, in order to suppress the occurrence of abnormal noise at the time when the excessive-vibration restraining part comes into contact with the voice coil 30, the excessive-vibration restraining part 108 may have the protrusion part covered by a tube formed with silicone resin. The excessive-vibration restraining part 108 can be altered as necessary.

### [Assembly Structure]

FIGS. 19 to 21 are views illustrating an assembly structure of a speaker device according to an embodiment of the present invention. FIG. 19 is a plan view illustrating a state where a driving part is mounted on the first component member 100A. A pair of the magnetic circuits 20, a pair of the voice coils 30 (voice coil support parts 40), and a vibration direction converter part 50 (link body 50L) are mounted at the first component member 100A to which a diaphragm 10 and an edge 11 are attached.

The magnetic circuit 20 is mounted at the first component member 100A, having a magnet joined to one side magnetic pole member 22 shown in a broken line. The magnetic pole member 22 includes a plurality of projection parts 22p, which fit into the above-mentioned receiving parts 105.

The voice coil 30 is elastically held by the static part 100 via a holding part 15. The holding part 15 restricts the vibration of the voice coil 30 to one axial direction and restricts the movement in other directions. The voice coil 30 is supported by the voice coil support part 40 and is held by an attachment unit 16 via the holding part 15. The attachment unit 16 is mounted at the first component member 100A, whereby the attachment and positioning of the voice coil 30 are simplified.

The vibration direction converter part 50 has a first link part 51A and a second link part 51B as a link body 50L, and the one end part of the second link part 51B is supported by the first link part 51A while the other end part of the second link part 51B is supported by the bridge part 102. The bridge part 102 supporting the second link part 51B is formed in a plane shape, and a connecting portion 104 where the other end part of the second link part 51B and the bridge part 102 are connected to each other forms a plane face.

The other end part of the second link part 51B fits into the bridge part 102, whereby the vibration direction converter part 50 is connected with the bridge part 102. A protrusion part 104A is formed at the connecting portion 104 of the bridge part 102, and a connecting part 53C which is integrally formed with the end part of the second link part 51B via the hinge part 52 has a hole part 104B into which a protrusion part 104A is inserted.

The protrusion part 104A of the connecting portion 104 in the bridge part 102 functions as a positioning part 102E positioning the vibration direction converter part 50 with respect to the static part 100. The protrusion part 104A is inserted into the hole part 104B provided in the connecting part 53C which is integrally formed with the end part of the second link part 51B via the hinge part 52, whereby the vibration direction converter part 50 is positioned with respect to the static part 100.

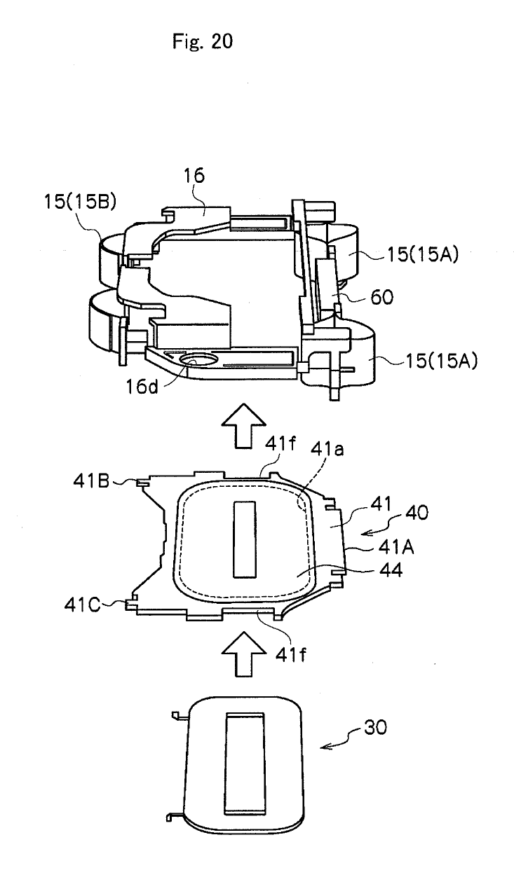

FIG. 20 is a view illustrating an attachment structure of the voice coil. The voice coil 30 having a wound conducting member is supported by a voice coil support part 40 and the voice coil support part 40 is held at the attachment unit 16 via a holding part 15. The voice coil support part 40 has a plane shaped base 41 made of an insulating material having an opened portion 41a attaching the voice coil, and the one side of the opening is covered by a protection film 44, and the voice coil 30 is attached in the attachment portion 41a.

The outer end parts of a pair of holding parts 15 (15A) are connected with the attachment unit 16 respectively on one end part side of the attachment unit 16, and the inner end parts of the pair of the holding parts 15 (15A) are connected with a connecting portion 60. Further, on another end part side of the attachment unit 16, a single holding part 15 (15B) is attached, and the center part of the holding part 15 (15B) is connected to the attachment unit 16, while both end parts of the holding part 15 (15B) are attached to both end parts 41B, 41C of the voice coil support part 40. The end part 41A of the voice coil support part 40 is connected to the connecting portion 60. The connecting portion 60 is a member connecting the voice coil 30 with the vibration direction converter part 50.

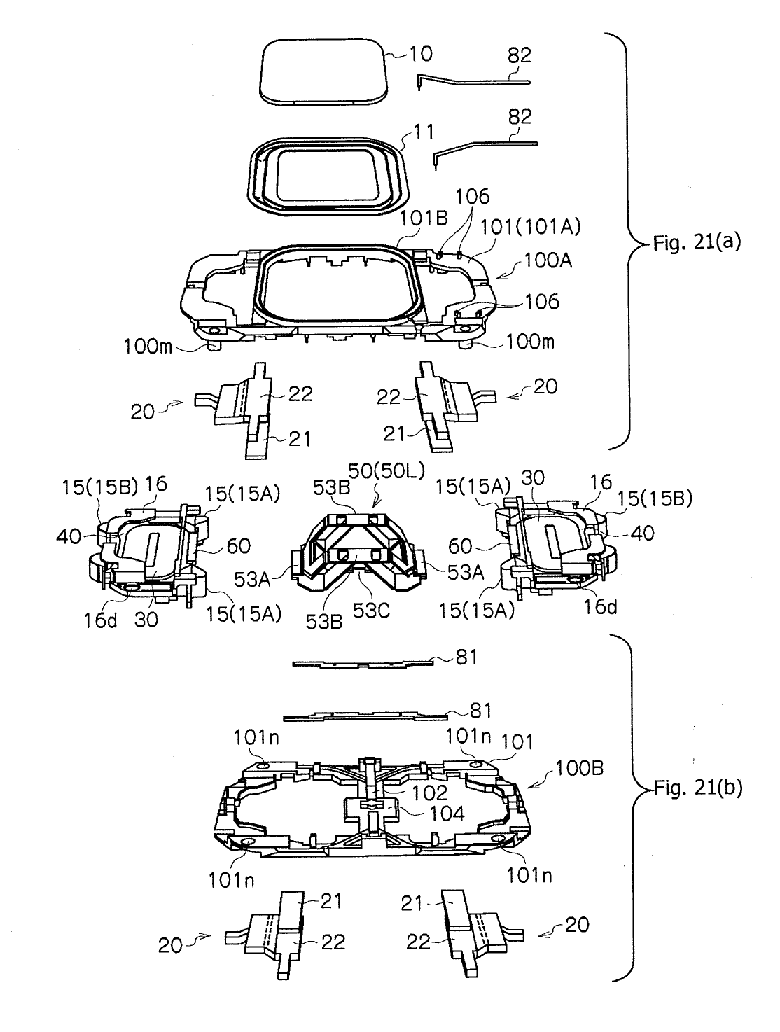

FIG. 21 is an exploded view of an entire speaker device, and the speaker device is assembled in the following order. At one side of the first component member 100A and the second component member 100B, a projection part 100m is formed projecting toward the attachment unit 16 while a recessed part 100n into which the projection part 100m is inserted is formed at the other side, and a through hole 16d is formed at the attachment unit 16 and the projection part 100m passes through the through hole 16d. In the example shown in the drawing, a plurality of projection parts 100m are formed on the inner face of the first component member 100A and the through holes 16d are opened opposite these projection parts 100m while the recessed parts 100n are formed on the inner face side of the second component member 100B. Through holes may be formed in place of the recessed parts 100n.

A method of manufacturing such a speaker device principally comprises: a step of attaching the voice coil 30 to the end part on the voice coil side of the vibration direction converter part 50, a step of attaching the diaphragm 10 to the end part on the diaphragm side of the vibration direction converter part 50, a step of attaching the diaphragm 10 to the static part 100 directly or via other member and a step of attaching the driving part 14 such as the magnetic circuit 20 to the static part 100.

When specifically assembling such a speaker device in each step, the connecting parts 53A of the vibration direction converter part 50 are inserted respectively into the connecting portions 60, whereby the vibration direction converter part 50, the attachment unit 16 that has already been unitized, the voice coil support part 40, and the holding part 15 (first holding part 15A, second holding part 15B) are integrally formed, and the projection part 100m of the first component member 100A or the second component member 100B fits into the through hole 16d of the attachment unit 16 whereby a pair of the magnetic pole members (yoke 22, magnet 21) of the magnetic circuit 20 is respectively positioned relative to the static part 100 (the first component member 100A, the second component member 100B) such that the pair of the magnetic pole members sandwiches the voice coil 30 and the first component member 100A and the second component member 100B sandwich the voice coil 30 and the pair of the magnetic pole members. As such, a static connecting part 53C of the vibration direction converter part 50 fits into the connecting portion 104 formed in the bridge part 102 of the second component member 100B and unmovably supported therein, and other components such as the attachment unit 16 are also arranged at given positions with respect to the first component member 100A and the second component member 100B.

In the example shown in the drawing, first, one side magnetic pole member (yoke 22, magnet 21) of the magnetic circuit 20 is mounted at the inner side of the first component member 100A and then the attachment unit 16, the vibration direction converter part 50 and so forth are sequentially mounted and positioned respectively, then, the second component member 100B is stacked to sandwich each component between the second component member 100B and the first component member 100A while mounting the other side magnetic pole member (yoke 22, magnet 21) of the circuit 20. As such, the projection part 100m formed at the first component member 100A is inserted into the through hole 16d of the attachment unit 16 and the recessed part 100n of the second component member 100B, and thereby the attachment unit 16, the voice coil support part 40, and the holding part 15 (first holding part 15A, second holding part 15B) are fixed between the first component member 100A and the second component member 100B. Finally, the connecting part 53B of the vibration direction converter part 50 and the diaphragm 10 are joined by adhesive as a joining member, while the outer periphery part of the diaphragm 10 is attached to the rim of the outer peripheral frame part 101B of the first component member 100A via the edge 11.

Also, the speaker device may be assembled in the following order. First, a lead wire 82 is connected to terminal parts 81, 81 (step of the connection between terminal parts and a lead wire). Next, a magnet 21 is connected to a yoke part 22 (step of assembling a magnetic circuit). Next, the terminal parts 81, 81 to which the lead wire 82 is connected are attached to the outer peripheral frame part 101 A of the first component member 100A (step of the attachment between the static part and the terminal part). Next, a pair of the attachment units 16 to which the above-mentioned voice coils 30 are attached is attached to the first component member 100A (step of the attachment between the static part and the attachment unit). At this point, the terminal parts 81, 81 and the holding parts 15A attached to the attachment unit 16 are electrically connected to each other by soldering and so forth (step of the connection between the terminal part and the holding part). Next, the connecting portion 104 is attached to the voice coil 30 (step of attachment between the voice coil and the connecting portion). Next, the static connecting part 53C of the vibration direction converter part 50 is attached to the connecting portion 104 (step of the connection between the vibration direction converter part and the connecting portion). Next, the second component member 100B is arranged on the first component member 100A (step of assembling the static part). After this, the magnetic pole member (yoke part) 22 to which the magnet 21 is connected is attached to the outer peripheral frame part 101 of the second component member 100B (step of the attachment between the static part and the magnetic circuit). Next, the diaphragm 10 and the edge 11 (vibrating body) are attached to the second outer peripheral frame part 101B of the first component member 100A (step of the attachment between the static part and the vibrating body). Next, the vibrating body and the vibration direction converter part are connected together (step of the attachment between the vibrating body and the vibration direction converter part). Next, the magnetic pole member (yoke part) 22 to which the magnet 21 is connected is attached to the outer peripheral frame part 101A of the first component member 100A (step of the attachment between the static part and the magnetic circuit). Finally, a lead wire 82 is attached to a guiding part 106 provided at the outer peripheral frame part 101A of the first component member 100A (step of the attachment between the static part and the lead wire). Further, the order of the above steps may be changed as necessary.

And, the vibration direction converter part 50 is connected with the pair of attachment units 16 to which the voice coil 30 is attached, and the first component member 100A and the second component member 100B are connected so as to sandwich the pair of attachment unit 16 and the vibration direction converter part 50. Further, the upper end part of the first link part 51A of the vibration direction converter part 50 is connected to the diaphragm 10 via the hinge part 52 and the lower end part of the second link part 51B is connected to the connecting portion 104 of the bridge part 102 via the hinge part 52.

### [Embodiment/Variation/Example of Installation]

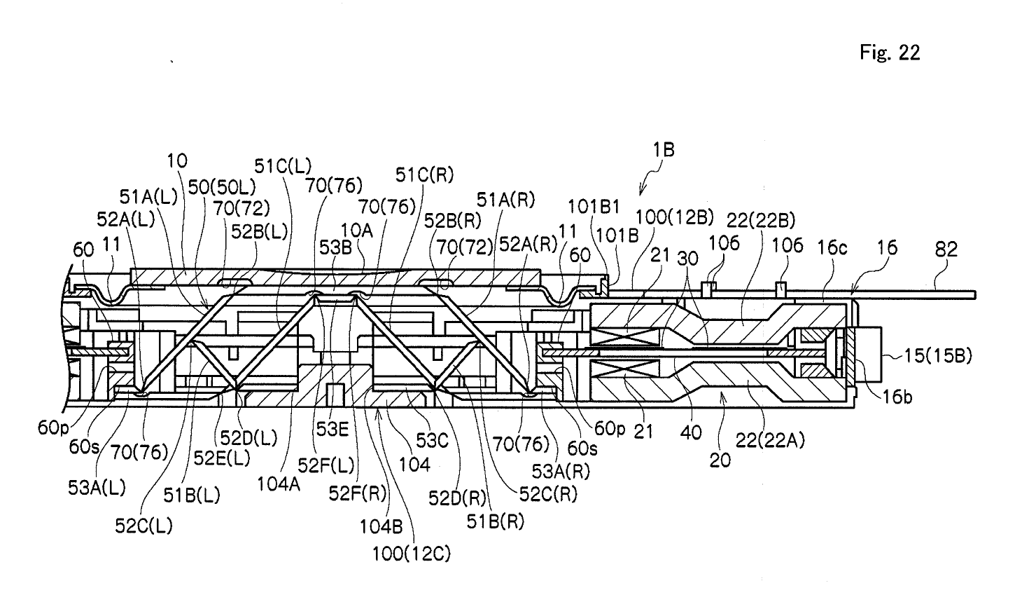

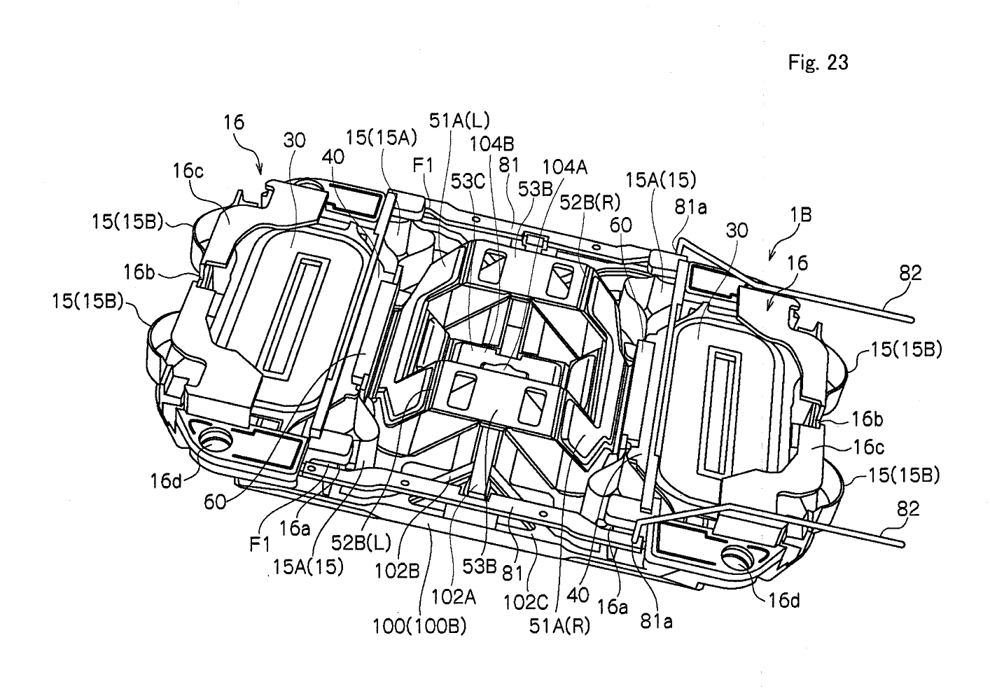

FIG. 22 and FIG. 23 are views illustrating an embodiment of the present invention. FIG. 22 is a partial cross-sectional view illustrating the above-mentioned speaker device 1B in a state where the assembly is completed. FIG. 23 is a perspective view illustrating the speaker device 1B in a state where the assembly is completed without the first component member 100A. The same symbol is applied to common parts, thereby the same description is not partially repeated.

In the example shown in FIG. 15, the diaphragm 10 viewed from the sound emission direction is formed in a rectangular shape and a curved part 10A, which has an elliptical appearance with a recessed cross-sectional shape, is formed near the center part of the diaphragm 10, whereby a given bending rigidity is applied in the vibration direction of the diaphragm 10 and the vibration direction of the voice coil 30. Also, the curved part 10A having the recessed shape is formed in the diaphragm 10, whereby the density of the curved part 10A is increased to be larger than the density in other part of the diaphragm 10, and thereby rigidity can be comparatively increased. Further, when a pair of the vibration direction converter parts 50 is oppositely arranged, the curved part 10A is formed between a pair of the hinge parts 52B that are formed between the vibration direction converter part 50 and the diaphragm 10.

The diaphragm 10 has rigidity (including bending rigidity) in the vibration direction of the diaphragm 10, whereby the occurrence of the deflection of the diaphragm 10 and so forth is prevented, and thus the occurrence of phase difference between sound waves, the degradation of acoustic characteristic due to the occurrence of divided vibration, and so forth can be prevented. Also, the curved part 10A is formed between a pair of the hinge parts 52B that are formed between the vibration direction converter part 50 and the diaphragm 10, whereby the occurrence of deflection can be prevented.

Further, the diaphragm 10 is formed substantially in a rectangular shape, including a short axis in the vibration direction of the voice coil 30 and a long axis in the direction orthogonal to the vibration direction of the voice coil 30, and a reinforcing part may be formed in a direction of the long axis or the short axis. The reinforcing part is, for example, a groove part having a V-shape or other shape cross-section, and is formed linearly, annularly or in a reticular pattern on the front or rear face of the diaphragm 10. For example, a filling material such as a damping material may be applied to (filled in) the inside of the groove part. As such, by filling the groove part with a filling material the rigidity of the diaphragm 10 (including bending rigidity) can be improved, thereby the peaks and dips of speaker sound pressure frequency characteristic can be decreased. Further, as another example of the reinforcing part, for example a fiber-system member made of unwoven fabric (not shown) and so forth may be applied instead of forming a groove part. As such, a reinforcing part 10B is formed with a fiber-system member whereby the rigidity (bending rigidity) of the diaphragm 10 can be improved, and thus when the diaphragm 10 vibrates, deformation such as deflection caused by vibration or air resistance which is transmitted from the vibration direction converter part can be prevented from occurring in the diaphragm 10. Further, since the reinforcing part 10B is provided, the internal loss of the diaphragm 10 can be improved.

Further, the diaphragm 10 is formed with a first layer made of foamed resin including acrylic resin, etc. and a second layer including a fiber-system member such as a glass fiber, configuring a laminate structure in which the first layer is sandwiched between a pair of the second layers. As forming material of the diaphragm 10, for example, a resin-system material, a metal-system material, a paper-system material, a fiber-system material, a ceramics-system material, a compound material, etc. may be adopted.

The edge 11, vibratably supporting the diaphragm 10 at the frame 12, is arranged between the diaphragm 10 and the frame 12 as the static part 100, and the inner periphery part supports the outer periphery part of the diaphragm 10 while the outer periphery part is connected to the frame 12 directly or via other member, and thus the diaphragm 10 is held at a prescribed position. As other member, an elastic member functioning as a packing (a resin member included), adhesive resin, and so forth are listed. Specifically, the edge 11 vibratably supports the diaphragm 10 in the vibration direction (Z axial direction), and restrains vibration in the direction orthogonal to the vibration direction (Y axial direction). The edge 11 is formed in a ring shape (annular shape) viewed from the sound emission direction, and its cross-section is formed in a prescribed shape, for example, a recessed shape, protruding shape, corrugated shape, etc. in the sound emission direction. As the forming material of the edge 11, conventional materials, for example, fur, cloth, rubber, resin, these filler-applied materials, rubber or resin member molded in a prescribed shape, may be adopted. Further, a part or whole circumference of the edge 11 may have a protrusion part projecting toward the front face (face of the sound emission side) or the rear face (the face opposite the sound emission side) or a recessed shape such that the rigidity of the edge 11 in a prescribed direction is increased.

In a state where the component member 100A and the second component member 100B are connected each other, a second connecting part 53B of the vibration direction converter part 50 is connected to the rear face of the diaphragm 10 that is supported by the first component member 100A, and a static connecting part 53C of the vibration direction converter part 50 is connected to a connecting portion 104 that is formed at the center part of a bridge part 102 in the second component member 100B.

The second connecting part 53B is integrally formed with the end part of the first link part 51A via the hinge part 52B, and the second connecting part 53B and the diaphragm 10 are connected to each other such that the end part of the first link part 51A and the diaphragm 10 are connected to each other. Further, a recessed part is formed on the face of the sound emission direction side of the diaphragm 10 that is opposite the connecting part 53B, thereby the diaphragm 10 has rigidity.

The static connecting part 53C is integrally formed with the end part of the second link part 51B via the hinge part 52D, and a through-hole 104B is formed in the connecting part 53C. The protrusion part 104A of the connecting portion 104 is inserted into the through-hole 104B such that the connecting portion 104 and the end part of the second link part 51B are connected to each other.

The voice coil support part 40 supporting the voice coil 30 and the vibration direction converter part 50 are connected to each other via a connecting portion 60. The connecting portion 60 is attached as extending along the width of the voice coil support part 40. In the connecting portion 60, a connecting step part 60s is formed such that the first connecting part 53A of the vibration direction converter part 50 can be detachably connected to the connecting portion and a through-hole 60p passing through the connecting portion in the vibration direction of the voice coil support part 40 is formed. The through-hole 60p is a vent hole which is formed to reduce air resistance that is applied to the connecting part 60 in response to the vibration of the voice coil supporting part 40. The connecting portion 60 connects the first connecting part 53A of the vibration direction converter part 50 with the end part of the voice coil support part 40 with an interval such that the height of the magnetic circuit 20 is included within the height of the vibration direction converter part 50.

The voice coil support part 40 and the connecting portion 60 are held at the static part 100 by the holding part 15. The holding parts 15 is provided with a first holding part 15A and a second holding part 15B comprising a curved plate shape member which allows one direction transformation in the vibration direction of the voice coil support part 40 but restricts transformation in the other directions. The first holding part 15A and the second holding part 15B hold the voice coil support part 40 to the first component member 100A and the second component member 100B via an attachment unit 16. The first holding part 15A holds the connecting portion 60 to one side part of the attachment unit 16, the end parts inside the first holding part 15A provided at right and left sides are connected to both outside end parts of the connecting part 60, and each end part outside the first holding part 15A is connected to the attachment 16 respectively. Further, the first holding part 15A is formed with conducting metal, and electrically connected to a lead wire pulled out from the end part of the voice coil 30 such that an audio signal is supplied to the voice coil 30 via the first holding part 15A. Further, the first holding part 15A is electrically connected to these linear terminal parts 81, 81 that are supported by the second component member 100B, and electrically connected to the outside via lead wires 82, 82 that are electrically connected to these terminal parts 81, 81 respectively.

The center part of the second holding part 15B is connected to the other side part of the attachment unit 16, and both end parts of the second holding part 15B are connected to both ends of the voice coil support part 40. Here, the second holding part 15B is arranged within the width of the voice coil support 40, such that a holding body of the voice coil 40 takes up little space in the width direction of the voice coil support part 40. Further, the second holding part 15B is formed with a continuous member and thereby the center portion thereof is also formed in a continuous shape. However, the second holding part 15B may be formed with a plurality of members without particular limitations. Further, a part of the second holding part 15B is arranged projecting outside from the static part 100, however the arrangement of the second holding part 15B may be altered to be housed inside the static part 100 without being limited to the above arrangement.

In order to input an audio signal to the voice coils 30, 30 that correspond to a plurality of driving parts 14, a pair of common terminal parts 81, 81 is provided on the static part 100 for a plurality of the voice coils 30, 30, extending from one voice coil 30 to another voice coil 30 of the plurality of voice coils 30, 30. Further the terminal parts 81, 81 are arranged inside an opening part (not shown), which is formed between a first frame 12B (first component member 100A) and a second frame 12C (second component member 100B) that constitutes a frame 12 as the static part 100. As such, the space for arranging terminal parts can be reduced to be less than when terminal parts are provided respectively at one end and another end of each voice coil 30, thereby making it possible to reduce the size or the thickness of the speaker device. Further, the terminal parts 81, 81 can be stably fixed to the static part 100, thereby a bad connection to the voice coils 30, 30 can be avoided. Further, the terminal parts 81, 81 are formed in a shape that has a long axis extending from one voice coil 30 to another voice coil 30 and a short axis crossing the long axis. With such an elongated shape, the efficiency of installation space can be improved.

A connecting part 81a is formed at the terminal parts 81, 81, connected to lead wires 82, 82 electrically connected to the outside, and thus the terminal part 81, 81 and the lead wire 82 are electrically connected at the connecting part 81 a. Further the lead wire 82 is fixed to the side face of the static part 100, and the outer peripheral frame part 101 of the static part 100 has a side face to which the lead wire 82 is attached, and a guiding parts 106, 106 are formed on the side face of the static part 100 to guide the lead wire 82.

Meanwhile, a conducting layer 32 is formed on the voice coil support part 40 (base) that supports the voice coil 30, connected to a voice coil lead wire 31 formed with a conducting member. The conducting layer 32 is pattern formed on the voice coil support part 40 (base) so as to surround the conducting member of the voice coil 30, and thus the conducting layer 32 electrically connects the conducting member of the voice coil 30 and the holding part 15 via the voice coil lead wire 31.

A lead wire is formed on the holding part 15 to electrically connect the voice coil 30 to the terminal part 81, the conducting layer 32 and the lead wire of the holding part 15 are electrically connected, the holding part 15 and the end parts of the terminal parts 81, 81 are electrically connected, and the lead wire 82 is connected to the terminal part 81, 81, whereby an audio signal is inputted from the outside into the voice coil 30.

A connecting part F1 is formed on the holding part 15, connected to the terminal parts 81, 81. The connecting part F1 is extended in a direction crossing the vibration direction (Z axial direction) of the diaphragm 10 and is formed in a plane shape so as to come into contact with the terminal parts 81, 81. Further, a connecting part (not shown) is formed on the holding part 15 to connect to the voice coil lead wire 43, extending in a direction crossing the vibration direction (Z axial direction) of the diaphragm 10 and is formed in a plane shape so as to come into contact with the end part of the voice coil lead wire 43.

The attachment unit 16 has an integral supporting part 16c which integrally supports a first connecting part 16a and a second connecting part 16b wherein the first connecting part 16a to which the end part of the first holding part 15A is connected is provided at both right and left sides of the connecting portion 60 and the second connecting part 16b to which the second holding part 15B is connected is provided at the rear of the voice coil support part 40. Further, connection through-holes 16d, into which projection parts 100m provided at the first component member 100A of the static part 100 are inserted, are provided at the four corners of the attachment unit 16 such that the attachment unit 16 is fixed at a given position with respect to the static part 100.

One side magnetic pole member (yoke part) 22A of the magnetic circuit 20 is attached to the first component member 100A, while the other side magnetic pole member (yoke part) 22B is attached to the second component member 100B. Further, the first component member 100A and the second component member 100B are connected to each other such that the space between the magnetic pole members (yoke parts) 22 or the space between the magnets 21 becomes a magnetic gap. Here, the magnetic pole members (yoke part) 22 (22A, 22B) are formed in a step-like shape, and one of a plurality of magnetic gaps is formed between the magnets 21, 21 while the other is formed between the proximate faces of the magnetic pole members 22A, 22B.

According to this embodiment, the height of the magnetic circuit 20 is substantially the total height of the entire device, and the voice coil support part 40 is configured to vibrate near the center of the magnetic circuit 20. Further, the end part of the voice coil support part 40 and the end part of the vibration direction converter part 50 are connected at different heights via the connecting portion 60, whereby each link part of the vibration direction converter part 50 can secure a sufficient length within the height of the device. Further, a part of the height of the magnetic circuit 20 can be included within the height of the vibration direction converter part 50.

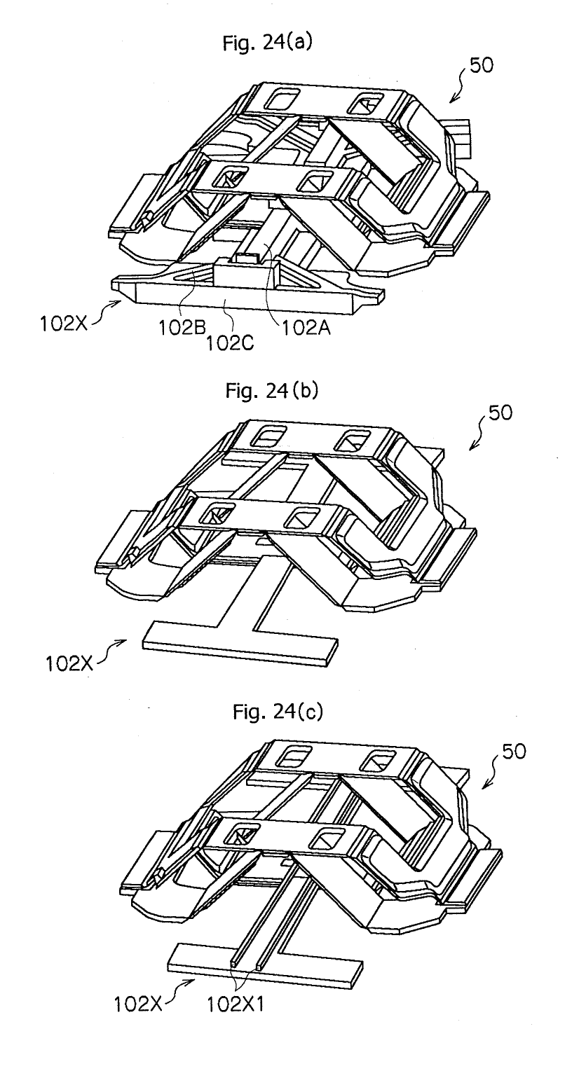

According to the aforementioned description, the bridge part 102 is formed integrally with the second component member 100B and the vibration direction converter part 50 is connected with the connecting portion 104 of the bridge part 102. However, without being limited to the above configuration, a bridge part 102X may be formed as a part of the vibration direction converter part 50 such that the bridge part 102X can be supported by the outer peripheral frame part 101. FIG. 24 is a view illustrating the variation. FIG. 24(a) is a view illustrating an example wherein the bridge part 102X integrally formed with the vibration direction converter part 50 is provided with a first projection part 102A, a second projection part 102B and a third projection part 102C. FIG. 24(b) is a view illustrating another example wherein the bridge part 102X integrally formed with the vibration direction converter part 50 is formed in a plane shape. FIG. 24(c) is a view illustrating another example wherein the bridge part 102X integrally formed with the vibration direction converter part 50 is formed in a plane shape and a projection part 102X1 is formed in parallel in a longitudinal direction.

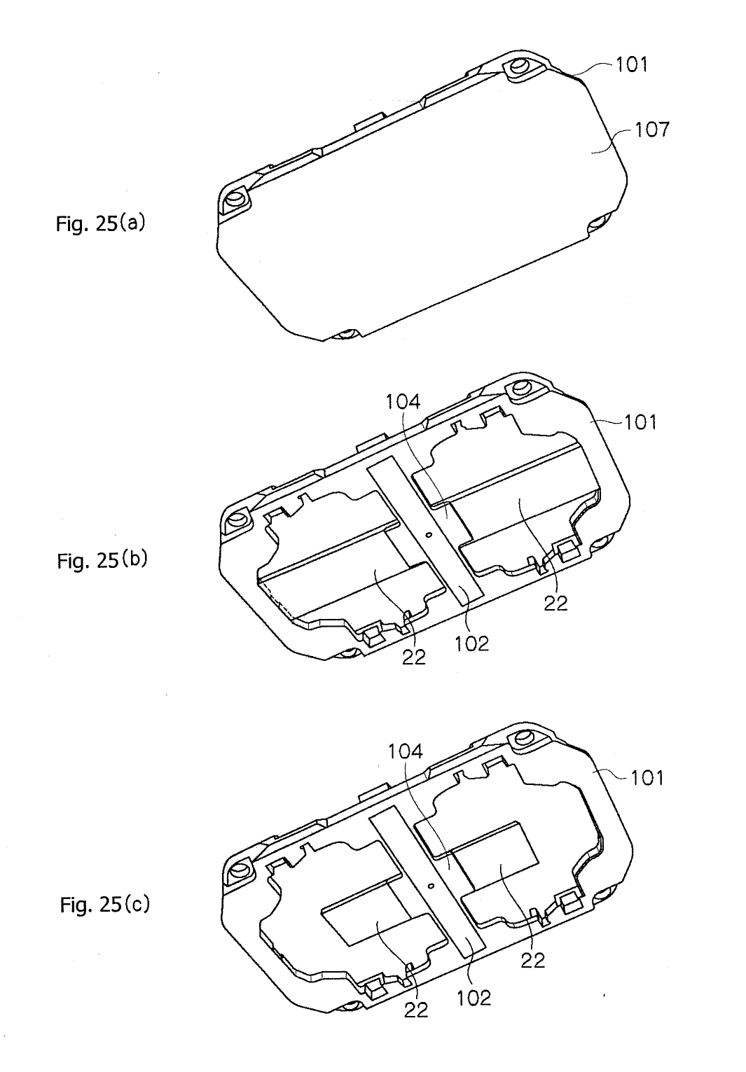

FIG. 25 is a view illustrating a variation of the second component member 100B. FIG. 25(a) is a view illustrating the second component member 100B provided with a plane shaped bottom part 107. According to this variation, a reaction force is applied to the vibration direction converter part 50 from a bottom part 107. FIG. 25(b) is a view illustrating a bridge part 102 which is formed in two directions crossing with respect to the outer peripheral frame part 101. According to this variation, the outer peripheral frame part 101 itself is reinforced by the bridge part 102.

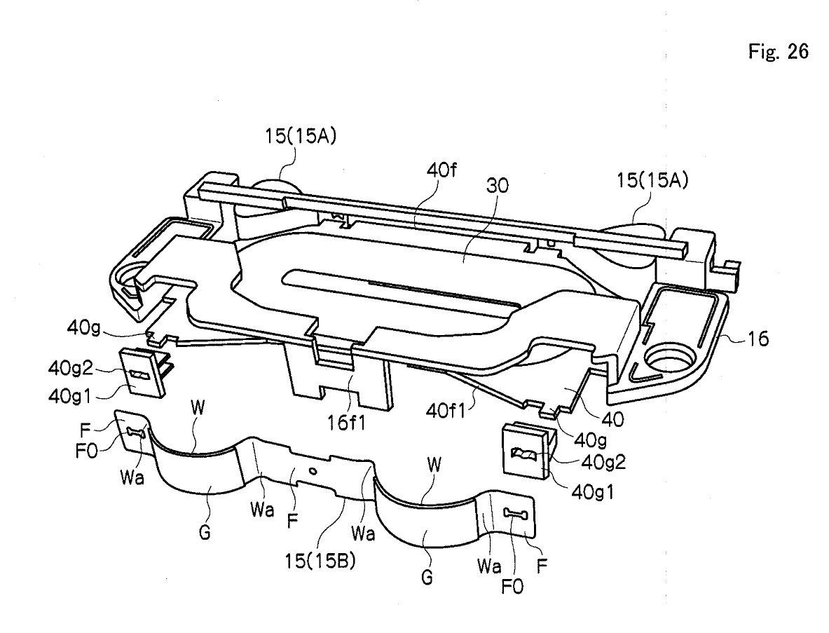

FIG. 26 is a view illustrating the connection between the holding part 15 and the attachment unit 16. The second holding part 15B which is integrally formed member and the attachment unit 16 are connected via adhesive resin. Right and left flat parts F, F at both ends of the holding part 15B are connected to connecting part 40g, 40g at both right and left end parts of an end edge 40f1 via connecting components 40g1, 40g2 which have holes 40g2 respectively, and a flat part F at the center of the second holding part 15B is connected to a connection end part 16f1 of the attachment unit 16. The end edge 40f1 of the voice coil support part 40 on the side opposite the side of the vibration direction converter part of the voice coil support part 40 is formed in a recessed shape with respect to the side of the voice coil 30, and the voice coil support part 40 is formed in a plane shape such that the voice coil support part 40 is prevented from coming into contact with the attachment unit 16 when the voice coil support part is vibrated in response to the vibration of the voice coil 30. Specifically, a comparatively large interval is formed between the connection end part 16f1 of the attachment unit 16 and the end edge 40f1 of the voice coil support part 40 while the voice coil support part 40 is formed in a plane shape such that the end edge 40f1 of the voice coil support part 40 is projected toward the second holding part 15B as it gets closer to the flat part F at both right and left end parts of the second holding part 15B. Further, holes are formed in the flat part F of both right and left end parts of the second holding part 15B to insert the connecting parts 40g into the holes at both right and left end parts of the end edge 40f1 of the voice coil support part 40.

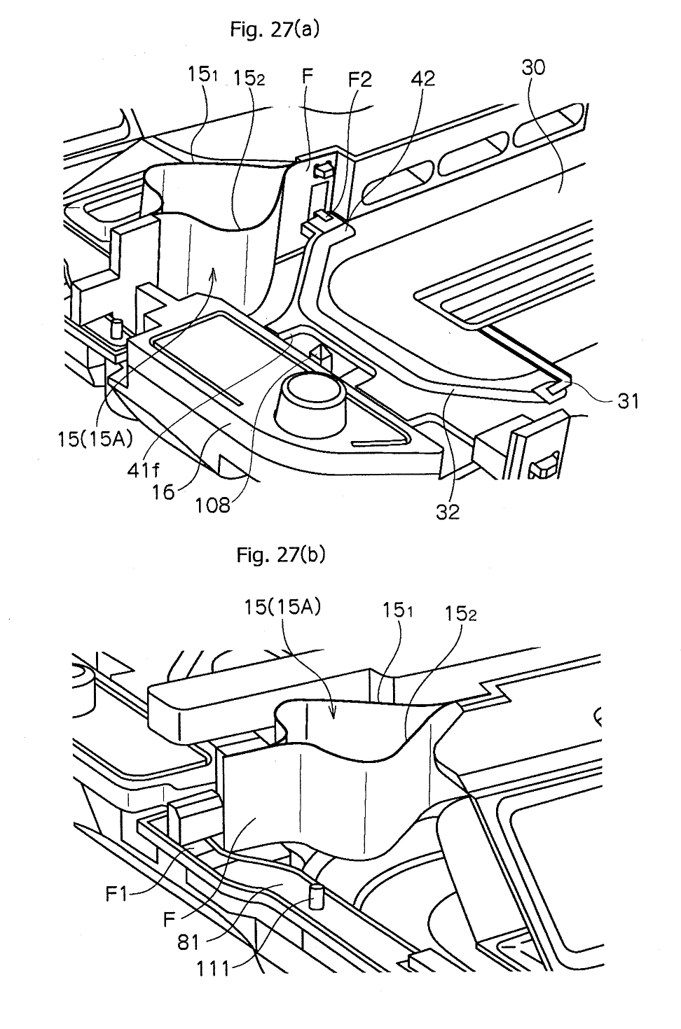

FIG. 27 is an enlarged view illustrating an electrical connection structure of the holding part. FIG. 27(a) is a view illustrating in detail one connecting face F2 of the first holding part 15A being connected to the connection terminal part 42 of the voice coil lead wire 32 (conducting layer). FIG. 27(b) is a view illustrating in detail the other connecting face F1 of the first holding part 15A being connected to a terminal part 81.

One end side connecting face F1 of the first holding part 15A is connected to the terminal part 81, and the other end side connecting face F2 is connected to the connection terminal part 42 of the voice coil lead wire 32. The terminal part 81 electrically connects one end side of a pair of the first holding parts 15A to the tinsel wire 82 (outside), and an audio signal inputted from the tinsel wire 82 is supplied to the voice coil lead wire 32 via the terminal part 81 and the first holding part 15A. The terminal part 81 is made of a rod-like conducting member, and a positioning hole is formed therein. A positioning protrusion 111 provided at the static part 100 is inserted into the positioning hole, whereby the terminal part 81 is positioned at a certain position relative to the static part 100. Further, insulation is applied to a part of the terminal part 81 and the face of conducting member is exposed in a region where the terminal part 81 and the connecting face F1 of the first holding part 15A are connected such that the terminal part 81 can be electrically connected to the first holding part 15A. Also, the terminal part 81 may be formed with a member having insulation properties (insulating member) such as a resin member and a conducting member is provided on the insulating member such that the connecting face F1 of the holding part 15 is electrically connected to the conducting member.

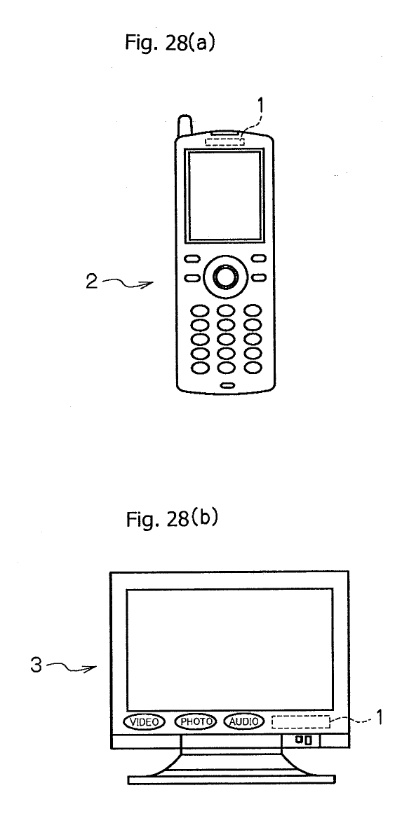

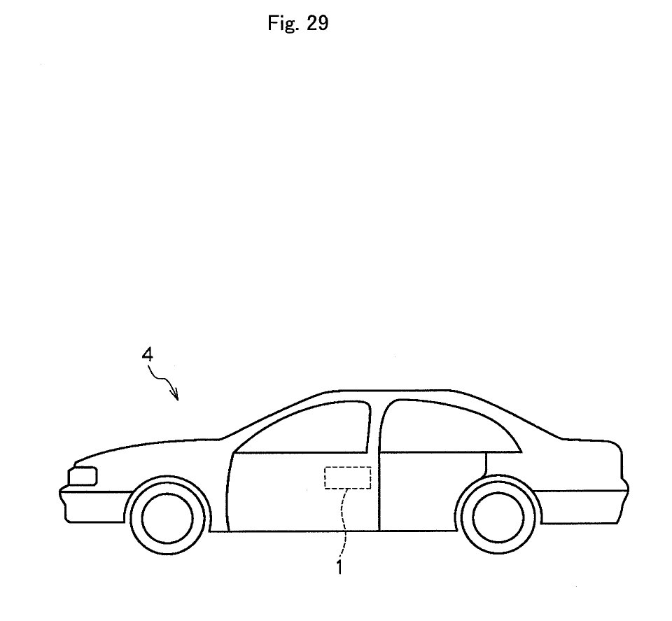

As described above, a speaker device 1 according to an embodiment of the present invention makes it possible to achieve a reduction in thickness while producing loud sound. Such a speaker device can be effectively used for various types of electronic devices and in-car devices. FIG. 28 is a view illustrating an electronic device equipped with a speaker device according to an embodiment of the present invention. An electronic device 2 such as a mobile phone or a handheld terminal as shown in FIG. 28(a) or an electronic device 3 such as a flat panel display as shown in FIG. 28(b) has a case as an attaching counterpart and the case housing the speaker device 1. Also, the speaker device 1 is attached to the side face of the case as an attaching counterpart of the electronic device. Since installation space required for the speaker device 1 can be decreased in the thickness direction, the thickness of the entire electronic device can be reduced. Further, a sufficient audio output can be obtained while reducing the thickness of the electronic device. FIG. 29 is a view illustrating a vehicle equipped with a speaker according to an embodiment of the present invention. In-car space of a vehicle 4 shown in FIG. 29 can be expanded due to the reduction in thickness of the speaker device 1. Particularly, even if the speaker device according to an embodiment of the present invention is attached to a door panel or a ceiling as the attaching counterpart, the bulge of the door panel can be comparatively reduced, whereby driver's operating space or in-car space can be expanded. Further, since a sufficiently audio output can be obtained, it is possible to pleasantly enjoy listening to music or radio broadcasting in a car even when driving on a noisy highway.

Further in a resident building, a hotel, an inn or a training facility as a building including a speaker device, when the speaker device 1 is provided on a wall or ceiling as the attaching counterpart, installation space in thickness direction required for the speaker device 1 may be reduced and thus enabling to save space in a room and make effective use of space. The hotel is capable of holding an event and accommodating many guests for conference, meeting, lecture, party, etc. Further, providing a room equipped with audiovisual equipment can be seen in recent years along with prevalence of a projector or a big-screen TV. On the other hand, there is also seen a living room, etc. used as a theater room without room equipped with audiovisual equipment. Also in this case, the living room, etc. can be easily converted to a theater room with the speaker device 1 while making effective use of space in the living room. More particularly, the placement at which the speaker device 1 is arranged may be, for example, ceiling or wall, etc. (attaching counterpart).

Although embodiments of the present invention are described with reference to the drawings, specific configurations are not limited to these embodiments, and modifications not departing from the subject matter of the present invention are included in the scope of the present invention. Further, the technology of each embodiment described above can be used by each other. In addition, PCT/JP2008/051197 filed on Jan. 28, 2008, PCT/JP2008/068580 filed on Oct. 14, 2008, PCT/JP2008/069480 filed on Oct. 27, 2008, PCT/JP2008/069269 filed on Oct. 23, 2008, PCT/JP2009/053752 filed on Feb. 27, 2009, PCT/JP2009/053592 filed on Feb. 26, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009 and PCT/JP2009/055528 filed on Mar. 19, 2009 are incorporated by reference into the present application.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A speaker device comprising:
a diaphragm, a static part vibratably supporting said diaphragm in a vibration direction and a driving part applying vibration to said diaphragm in response to an audio signal, said driving part being provided at said static part, wherein
said driving part includes:
a magnetic circuit forming a magnetic gap in a direction different from the vibration direction of said diaphragm;
a voice coil vibrating along said magnetic gap; and
a vibration direction converter part direction-converting said vibration of said voice coil and transmitting said vibration to said diaphragm, and
said vibration direction converter part includes a link body angle-converting a link part formed between said voice coil and said diaphragm, and
said static part includes an outer peripheral frame part surrounding said diaphragm and a bridge part bridging the inside of said outer peripheral frame part, and said bridge part applies a reaction force to said link body and has rigidity in the vibration direction of said link body.

2. The speaker device according to claim 1, wherein said bridge part has rigidity against a force received from said diaphragm via said link body.

3. The speaker device according to claim 1, wherein the compliance of said bridge part is substantially same or smaller than the compliance of said outer peripheral frame part in the vibration direction of said diaphragm.

4. The speaker device according to claim 1, wherein the thickness at said bridge part is substantially same or larger than the thickness at a part of said static part supporting said diaphragm or said magnetic circuit.

5. The speaker device according to claim 4, wherein a first projection part is formed in said bridge part, projecting toward the extending direction of said bridge part and toward the vibration direction of said diaphragm.

6. The speaker device according to claim 5, wherein a second projection part extending in a direction crossing said first projection part is formed within a face of said bridge part opposite said diaphragm.

7. The speaker device according to claim 6, wherein
a third projection part extending in a direction crossing said first projection part and said second projection part is formed within a face of said static part, and
a reinforcing part having a polygonal plane shape is formed within the face of said static part with a plurality of said second projection parts and said third projection part.

8. The speaker device according to claim 7, wherein
said vibration direction converter part includes said link part as a first link part and a second link part as said link body, and
one end part of said second link part is supported by said first link part and the other end part of said second link part is supported by said bridge part.

9.-15. (canceled)

16. The speaker device according to claim 1, wherein said static part is formed with a first component member arranged on the sound emission side and a second component member arranged on the side opposite the sound emission side.

17. The speaker device according to claim 16, wherein
said first component member is annularly formed and supports said diaphragm, and
said second component member has a said bridge part.

18. (canceled)

19. The speaker device according to claim 16, comprising
said outer peripheral frame part of said static part as a first outer peripheral frame part, and
said first component member includes a second outer peripheral frame part supporting said diaphragm inside said first outer peripheral frame part.

20. (canceled)

21. The speaker device according to claim 19, wherein
said magnetic circuit includes two magnetic pole members having magnets and arranged in two spaces defined by said voice coil, said two magnetic pole members having different magnetic poles each other, and
said first component member supports one of said magnetic pole members and, said second component member supports the other of said magnetic pole members.

22.-26. (canceled)

27. The speaker device according to claim 1, wherein said bridge part is formed as a part of said vibration direction converter part and is supported by said outer peripheral frame part.

28. (canceled)

29. The speaker device according to claim 1, wherein
a notch part is formed at an end edge extending in the vibration direction of said voice coil, and
a projection part projecting toward said voice coil is formed at said static part, a part of said projection part being arranged inside said notch part.

30. (canceled)

31. The speaker device according to claim 1, comprising a connecting portion arranged between an end part of said vibration direction converter part on said voice coil side and an end part of said voice coil on said vibration direction converter part side, wherein said connecting portion connects both said end parts such that positions of both said end parts are different in said vibration direction.

32. The speaker device according to claim 1, wherein
said vibration direction converter part is connected with an attaching counterpart having said diaphragm and said voice coil and having a hinge part near said attaching counterpart, and
a contact avoiding part avoiding a contact with said hinge is formed on the face side of said attaching counterpart near said hinge part.

33. The speaker device according to claim 1, wherein
said vibration direction converter part is connected with an attaching counterpart having said diaphragm and said voice coil and having a hinge part near said attaching counterpart, and
a housing part of adhesive material connecting said vibration direction converter part and said attaching counterpart is formed on the face side of said attaching counterpart opposite said hinge part.

34. The speaker device according to claim 1, wherein
said vibration direction converter part includes a rigid link part angle-variably and obliquely arranged between said voice coil and said diaphragm and hinge parts formed at both end parts of said link part, and
said hinge parts are formed with a bendable continuous member continuing at parts in both sides straddling said hinge part.

35. The speaker device according to claim 1, wherein
said voice coil has a planarly and annularly wound conducting member and a rigid base supporting said conducting member, and
a conducting layer is pattern formed at the outer surface of said conducting member in said base.

36. The speaker device according to claim 35, wherein a pair of said conducting layers is arranged so as to surround said conducting member and functions as a junction wire inputting an audio signal into said conducting member.

37. An electronic device comprising the speaker device according to claim 1.

38. A vehicle comprising the speaker device according to claim 1.

39. A building comprising the speaker device according to claim 1.

40. A method of manufacturing a speaker device,
said speaker device comprising
a diaphragm, a static part vibratably supporting said diaphragm,
a driving part applying vibration to said diaphragm in response to an audio signal, said driving part being provided at said static part, and
a rigid vibration direction converter part direction-converting said vibration of said voice coil of said driving part and vibrating said diaphragm in a direction different from said vibration direction of said voice coil, wherein said vibration direction converter part is connected to said voice and said diaphragm,
said method includes:
a step of connecting said voice coil to an end part of said vibration direction converter part on said voice coil side,
a step of connecting said diaphragm to an end part of said vibration direction converter part on said diaphragm side,
a step of connecting said diaphragm to said static part directly or via other member, and
a step of connecting said driving part to said static part.

41. The method of manufacturing a speaker device according to claim 40, wherein
said vibration direction converter part includes a link body angle-converting a link part formed between said voice coil and said diaphragm, and
said static part includes an outer peripheral frame part surrounding said diaphragm and a bridge part bridging the inside of said outer peripheral frame part, and
said method includes a step of connecting said link body to said static part.

42. A speaker device comprising:
a diaphragm, a static part and a driving part, wherein
said driving part includes a magnetic circuit, a voice coil and a vibration direction converter part direction-converting vibration of said voice coil and transmitting said vibration to said diaphragm, and
said vibration direction converter part includes a link body angle-converting a link part arranged between said voice coil and said diaphragm, and
said static part includes an outer peripheral frame part formed in an annular shape and a part extending from said outer peripheral frame part to said vibration direction converter part, and said part of said static part has rigidity in the vibration direction of said link body.
